(19) United States
(12) Patent Application Publication
(10) Pub. No.: US 2016/0012237 A1
(43) Pub. Date: Jan. 14, 2016

(54) AES IMPLEMENTATION WITH ERROR CORRECTION

(71) Applicant: IRDETO B.V., Hoofddorp (NL)

(72) Inventors: Yaser EFTEKHARI, Ottawa (CA); Michael Wiener, Ottawa (CA); Yongxin Zhou, Ottawa (CA)

(21) Appl. No.: 14/430,907

(22) PCT Filed: Mar. 27, 2013
(86) PCT No.: PCT/EP2013/056621

§ 371 Date: Mar. 24, 2015

(51) Int. Cl. G06F 21/60; H03M 13/00; H03M 13/15

(52) U.S. Cl. CPC G06F 21/602; H03M 13/157; H03M 13/616; H03M 13/617; H03M 13/63

(57) ABSTRACT

A method of cryptographically processing a block of data, the method comprising: receiving an encoded version of the block of data, wherein the encoded version of the block of data comprises the block of data encoded, at least in part, using an error control code; and processing the encoded version of the block of data using a predetermined function to generate an output, wherein the predetermined function is arranged so that the result of processing, with the predetermined function, a quantity of data encoded, at least in part, using the error control code equals the result of encoding, at least in part, with the error control code the result of performing encryption or decryption of the quantity of data according to the Advanced Encryption Standard, AES.

### FIELD OF THE INVENTION

The present invention relates to cryptographically processing a block of data.

### BACKGROUND OF THE INVENTION

Error control codes (ECCs) are very well-known. In particular, a sender may wish to send a message m to a receiver. In order for the sender to be able to communicate the message m reliably to the receiver over a noisy communications channel, the sender may use an ECC to add an amount of redundancy to the message m (in a process known as “encoding”) to generate a codeword c of the ECC. The sender may then send the codeword c to the receiver instead of just sending the message m to the receiver. The receiver may receive data c′ representing the codeword c that the sender sent out—the data c′ may be equal to the codeword c if the communications channel has not introduced any errors or noise into the codeword c; alternatively, the data c′ may be equal to the codeword c with the addition of one or more errors introduced by the noisy communications channel. The receiver may process the received data c′. If the ECC is an error correcting code, and if the number of errors introduced into the codeword c by the noisy communications channel to produce the data c′ does not exceed the error correcting capability of the ECC, then the redundancy introduced by the encoding performed by the sender allows the receiver to correct the errors and retrieve the original message m from the data c′ (in a process known as “decoding”). If the ECC is an error detecting code, and if the number of errors introduced into the codeword c by the noisy communications channel to produce the data c′ does not exceed the error detecting capability of the ECC, then the redundancy introduced by the encoding performed by the sender allows the receiver to detect (although not necessarily correct) the errors (in a process again known as “decoding”).

Some ECCs are so-called “block” ECCs. A block ECC transforms an original message m of length k symbols into a codeword c of length n symbols (where n>k), where the symbols are taken from some symbol alphabet. Suppose that an original amount of data D that is to be encoded with a block ECC comprises ak+b symbols (where a and b are integers, a≧0 and 0≦b<k). The original amount of data D may be encoded using the block ECC as follows. If a>0, then a messages m₁, . . . , mₐ, each of length k symbols, are formed from the original amount of data D (for example, message mᵢ comprises the ((i−1)k+1)^{th} symbol to the ik^{th} symbol of the data D)—these messages may then be separately encoded using the ECC to form respective codewords c₁, . . . , cₐ. If b≠0, then a message m* is formed, where the message m* comprises the remaining b unencoded symbols (in the above example, the last b symbols) of the original amount of data D; the remaining (k-b) symbols of the message m* could be redundant padding symbols (for example, “0” symbols), or could be some of the original amount of data D. This message m* is then encoded using the ECC to form a codeword c*. The ECC encoded form of the original amount of data D then comprises c₁, . . . , cₐ (if a>0) together with c* (if b≠0).

In the following, the symbols forming a message m or a codeword c are viewed as, and treated as, elements of the finite field GF(q), where q=p^{f} for some prime number p and positive integer f−i.e. GF(q) is the symbol alphabet. A string (or sequence) of t symbols s₀, s₁, . . . , sₜ₋₂, sₜ₋₁ is then said to correspond to, or can be represented by, the polynomial

$${s}_{t - 1} {X}^{t - 1} + {s}_{t - 2} {X}^{t - 2} + … + {s}_{1} X + {s}_{0} = {\sum }_{i = 0}^{t - 1} {s}_{i} {X}^{i} .$$

Thus, a message m comprising k symbols m₀, m₁, . . . , mₖ₋₂, mₖ₋₁ corresponds to, or is represented by, the polynomial

$$m ( X ) = {m}_{k - 1} {X}^{k - 1} + {m}_{k - 2} {X}^{k - 2} + … + {m}_{1} X + {m}_{0} = {\sum }_{i = 0}^{k - 1} {m}_{i} {X}^{i} ,$$

and a codeword c comprising n symbols c₀, c₁, . . . , cₙ₋₂, cₙ₋₁ corresponds to, or is represented by, the polynomial

$$c ( X ) = {c}_{n - 1} {X}^{n - 1} + {c}_{n - 2} {X}^{n - 2} + … + {c}_{1} X + {c}_{0} = {\sum }_{i = 0}^{n - 1} {c}_{i} {X}^{i} .$$

A particular class of block ECCs are the so-called “polynomial” ECCs. A polynomial ECC has an associated polynomial called its “generator” polynomial g(X) which has degree n-k and coefficients in GF(q). There are many ways of carrying out encoding using a polynomial ECC. One way, called “systematic encoding”, involves encoding the message m(X) as the codeword c(X), where c(X)=m(X)X^{n-k}+r(X) where r(X) is a “parity-check” polynomial defined as the remainder of dividing m(X)X^{n-k} by g(X). Another way, called “non-systematic encoding”, involves encoding the message m(X) as the codeword c(X), where c(X)=g(X)m(X). Other ways of forming a codeword c(X) from a message m(X) exist, but the polynomial w(X) is a codeword of the ECC if and only if w(X)=v(X)g(X) for some polynomial v(X) of degree at most k (the different encoding methods simply correspond to different mappings between the possible messages and the available codewords).

There are various well-known examples of polynomial ECCs. All “cyclic” ECC codes are polynomial ECCs—a polynomial ECC will be a cyclic code if and only if g(X) is a factor of Xₙ−1. So-called BCH codes are a particular form of polynomial ECC, in which the generator polynomial is chosen so that the Hamming distance between the codewords of the ECC is high (so that its error correction capability is correspondingly high). A subset of the BCH codes are the Reed-Solomon codes. For a Reed-Solomon code, let s and t be positive integers as design parameters for the code, then: the symbol alphabet is the finite field GF(2^{s}); n=2^{s}−1; the error correcting capability of the code is t; t relates to the message length k by k=n−2t; and the generator polynomial g(X) is based on a primitive polynomial p(X) of degree s over GF(2)—let α be a root of p(X), then g(X) can be defined as g(X)=(X+α)(X+α²) . . . (X+α^{2t}). Reed-Solomon codes are cyclic codes.

Polynomial ECCs are linear block codes. In particular, let δ₁ and δ₂ be elements of GF(q) and let m₁ and m₂ be two message polynomials, with corresponding codewords c₁ and c₂. Then the codeword that results from encoding the message δ₁m₁+δ₂m₂ is δ₁c₁+δ₂c₂.

As ECC codes and their properties are well-known, a more detailed discussion of them shall not be given herein. The skilled person is assumed to be knowledgeable about ECC codes, types of ECC codes, ways of performing ECC encoding, and corresponding ways of performing ECC decoding. For example, Reed-Solomon codes have been studied and documented in great detail, and the corresponding encoding and decoding methods are very well known.

The Advanced Encryption Standard (AES) is a well-known encryption algorithm, described in Federal Information Processing Standards Publication 197 (found at http://csrc.nist.gov/publications/fips/fips197/fips-197.pdf), the entire disclosure of which is incorporated herein by reference. AES is a symmetric block cipher, where the size of an input block is 128 bits and the size of the corresponding output block is also 128 bits. There are three different variations of AES, known as AES-128, AES-192 and AES-256: for AES-n, the size of the cryptographic key is n bits.

The AES algorithm maintains a “state”, which is a 4×4 matrix S, each element of the matrix S being a byte. Let the element at row r and column c of the state S be represented by S[r,c](0≦r<4 and 0≦c<4). An input block of data that is to be processed comprises 16 bytes, in[j](0≦j<16). The state S is initialised by setting S[r,c]=in[r+4c](0≦r<4 and 0≦c<4). The result of processing the input block of data is an output block of data that also comprises 16 bytes, out[j](0≦j<16). At the end of the processing, the output block of data is formed from the state S by setting the output block of data according to out[r+4c]=S[r,c](0≦r<4 and 0≦c<4). Each processing step or operation of the AES algorithm operates on the current state S, with the state S being modified at each step so as to move it from representing the input block of data to the output block of data. In the following, for each step or function/operation carried out when performing the AES algorithm, the result on the element S[r,c] of the state S of performing that step or applying that function/operation shall be represented by S′[r,c](0≦r<4 and 0≦c<4).

The AES algorithm involves a number, Nr, of “rounds”. For AES-128, Nr=10; for AES-192, Nr=12; for AES-256, Nr=14. The rounds shall be described shortly.

A key expansion routine is used to generate a key schedule from an initial cryptographic key K. The key schedule comprises Nr+1 so-called “round keys” RKⱼ (0≦j≦Nr), each round key being 128 bits. The details of the key expansion routine are not important for this disclosure and they shall, therefore, not be described in more detail herein. For more detail on this, see section 5.2 of Federal Information Processing Standards Publication 197.

In AES, bytes are viewed as elements of the field GF(2⁸), where multiplication in GF(2⁸) is modulo the irreducible polynomial x⁸+x⁴+x³+x+1.

FIG. 1 of the accompanying drawings provides an overview of encryption 100 using the AES algorithm.

The state S is initialised using an input block of data 110—data in[j](0≦j<16)—as described above.

Next, the state S is processed by an “AddRoundKey” function 120, using the round key RK₀.

Next, rounds 1, 2, . . . , Nr-1 are performed, one after the other. For round R (1≦R<Nr), the R^{th} round involves:
(a) processing the state S using a “SubBytes” function 130, followed by
(b) processing the state S using a “ShiftRows” function 140, followed by
(c) processing the state S using a “MixColumns” function 150, followed by
(d) processing the state S using the AddRoundKey function 120, using the round key RK_{R}.

Finally, the Nr^{th} round is performed, which involves:
(a) processing the state S using the SubBytes function 130, followed by
(b) processing the state S using the ShiftRows function 140, followed by
(c) processing the state S using the AddRoundKey function 120, using the round key RKNr.

Thus, the Nr^{th} round is the same as the previous Nr-1 rounds, except that it does not include the MixColumns function 150.

An output block of data 160—data out[j](0≦j<16)—can then be formed from the state S as described above.

The AddRoundKey function 120 involves XOR-ing the bytes of the current round key RK_{R} being used (0≦R<Nr) with the bytes of the state S. In particular, if the round key RK_{R} is a series of bytes k[j](0≦j<16), then element S[r,c] of the state S is XOR-ed with byte k[r+4c](0≦r<4 and 0≦c<4), so that the element S[r,c] of the state S becomes S′[r,c]=S[r,c]⊕k[r+4c].

The SubBytes function 130 operates on each of the 16 bytes of the state S separately as follows. The element S[r,c](0≦r<4 and 0≦c<4) is viewed as a element of GF(2⁸) and its multiplicative inverse in GF(2⁸) is determined. If we represent this inverse as a byte b that has bits b₇, b₆, . . . , b₁, b₀ (running from most to least significant bit), and if the result of applying the SubBytes function to the element S[r,c](i.e. the byte S′[r,c]) is a byte that has bits c₇, c₆, . . . , c₁, c₀ (running from most to least significant bit), then S′[r,c] may be calculated as:

$$[ \begin{matrix}{c}_{0} \\ {c}_{1} \\ {c}_{2} \\ {c}_{3} \\ {c}_{4} \\ {c}_{5} \\ {c}_{6} \\ {c}_{7}\end{matrix} ] = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 1 & 1 & 1 & 1 & 1 & 1 & 0 & 0 \\ 1 & 1 & 1 & 1 & 1 & 1 & 1 & 0 \\ 1 & 1 & 1 & 1 & 1 & 1 & 1 & 1\end{matrix} ] [ \begin{matrix}{b}_{0} \\ {b}_{1} \\ {b}_{2} \\ {b}_{3} \\ {b}_{4} \\ {b}_{5} \\ {b}_{6} \\ {b}_{7}\end{matrix} ] + [ \begin{matrix}1 \\ 1 \\ 0 \\ 0 \\ 0 \\ 1 \\ 1 \\ 0\end{matrix} ]$$

The SubBytes function 130 is often implemented simply by a lookup table. In particular, for 0≦r<4 and 0≦c<4, if S[r,c]=16u+v for integer values 0≦u,v<16, then the application of the SubBytes function 130 to S[r,c] changes the value S[r,c] to the value S′[r,c] given at row u and column v of Table 1 below. The values in Table 1 are in hexadecimal.

TABLE 1

| | | v | | | | | | | | | | | | | | | |
|---|---|---|---|---|---|---|---|---|---|---|---|---|---|---|---|---|---|
| | | 0 | 1 | 2 | 3 | 4 | 5 | 6 | 7 | 8 | 9 | 10 | 11 | 12 | 13 | 14 | 15 |
| u | 0 | 63 | 7c | 77 | 7b | f2 | 6b | 6f | c5 | 30 | 01 | 67 | 2b | fe | d7 | ab | 76 |
| | 1 | ca | 82 | c9 | 7d | fa | 59 | 47 | f0 | ad | d4 | a2 | af | 9c | a4 | 72 | c0 |
| | 2 | b7 | fd | 93 | 26 | 36 | 3f | f7 | cc | 34 | a5 | e5 | f1 | 71 | d8 | 31 | 15 |
| | 3 | 04 | c7 | 23 | c3 | 18 | 96 | 05 | 9a | 07 | 12 | 80 | e2 | eb | 27 | b2 | 75 |
| | 4 | 09 | 83 | 2c | 1a | 1b | 6e | 5a | a0 | 52 | 3b | d6 | b3 | 29 | e3 | 2f | 84 |
| | 5 | 53 | d1 | 00 | ed | 20 | fc | b1 | 5b | 6a | cb | be | 39 | 4a | 4c | 58 | cf |
| | 6 | d0 | ef | aa | fb | 43 | 4d | 33 | 85 | 45 | f9 | 02 | 7f | 50 | 3c | 9f | a8 |
| | 7 | 51 | a3 | 40 | 8f | 92 | 9d | 38 | f5 | bc | b6 | da | 21 | 10 | ff | f3 | d2 |
| | 8 | cd | 0c | 13 | ec | 5f | 97 | 44 | 17 | c4 | a7 | 7e | 3d | 64 | 5d | 19 | 73 |
| | 9 | 60 | 81 | 4f | dc | 22 | 2a | 90 | 88 | 46 | ee | b8 | 14 | de | 5e | 0b | db |
| | 10 | e0 | 32 | 3a | 0a | 49 | 06 | 24 | 5c | c2 | d3 | ac | 62 | 91 | 95 | e4 | 79 |
| | 11 | e7 | c8 | 37 | 6d | 8d | d5 | 4e | a9 | 6c | 56 | f4 | ea | 65 | 7a | ae | 08 |
| | 12 | ba | 78 | 25 | 2e | 1c | a6 | b4 | c6 | e8 | dd | 74 | 1f | 4b | bd | 8b | 8a |
| | 13 | 70 | 3e | b5 | 66 | 48 | 03 | f6 | 0e | 61 | 35 | 57 | b9 | 86 | c1 | 1d | 9e |
| | 14 | e1 | f8 | 98 | 11 | 69 | d9 | 8e | 94 | 9b | 1e | 87 | e9 | ce | 55 | 28 | df |
| | 15 | 8c | a1 | 89 | 0d | bf | e6 | 42 | 68 | 41 | 99 | 2d | 0f | b0 | 54 | bb | 16 |

Other ways of representing the SubBytes function 130 are possible.

The ShiftRows function 140 cyclically shifts the bytes of the last three rows of the state S. In particular, for row r of the state S (1≦r<4), the elements of row r are cyclically shifted by r positions to the left, i.e. the application of the ShiftRows function 140 to S[r,c] sets the value S[r,c] to the value S′[r,c] given by S′[r,c]=S[r,(c+r)(mod 4)](for 0≦r<4 and 0≦c<4).

With the MixColumns function 150, each column of the state S is processed by multiplying that column by a particular matrix. In particular, for 0≦c<4, the MixColumns function 150 operates on the c^{th} column according to:

$$( \begin{matrix}{S}^{′} [ 0 , c ] \\ {S}^{′} [ 1 , c ] \\ {S}^{′} [ 2 , c ] \\ {S}^{′} [ 3 , c ]\end{matrix} ) = ( \begin{matrix}2 & 3 & 1 & 1 \\ 1 & 2 & 3 & 1 \\ 1 & 1 & 2 & 3 \\ 3 & 1 & 1 & 2\end{matrix} ) ( \begin{matrix}S [ 0 , c ] \\ S [ 1 , c ] \\ S [ 2 , c ] \\ S [ 3 , c ]\end{matrix} )$$

where: multiplication by 1 means no change; multiplication by 2 means shifting to the left; and multiplication by 3 means shifting to the left and then XOR-ing the with the initial un-shifted value. Here, “shift” means a shift of the binary representation of the respective value to the left, as is known in the art (so that, for example, the binary value 10110011 becomes 101100110). After a shifting, the shifted value should be XOR-ed with 0x11B if the shifted value is larger than 0xFF.

Other ways of representing the MixColumns function 150 are possible. For example, the elements of the c^{th} column of the state S may be treated as coefficients of a four-term polynomial over GF(2⁸), with this polynomial then being multiplied modulo x⁴+1 by the polynomial 3x³+x²+x+2—the coefficients of the resultant polynomial then form the updated elements of the ch column of the state S.

FIG. 2 of the accompanying drawings provides an overview of decryption 200 using the AES algorithm.

Each of the AddRoundKey function 120, the SubBytes function 130, the ShiftRows function 140, and the MixColumns function 150 is invertible, as set out below.

The inverse of the AddRoundKey function 120, called InvAddRoundKey 220, is exactly the same as the AddRoundKey function 120.

The inverse of the SubBytes function 130, called InvSubBytes 230, can be implemented using the inverse of the transformation set out above in the description of the SubBytes function 130, or using a lookup table given by Table 2 below. The values in Table 2 are in hexadecimal. In particular, for 0≦r<4 and 0≦c<4, if S[r,c]=16u+v for integer values 0≦u,v<16, then the application of the InvSubBytes function 230 to S[r,c] changes the value S[r,c] to the value S′[r,c] given in Table 2 below at row u and column v.

TABLE 2

| | | v | | | | | | | | | | | | | | | |
|---|---|---|---|---|---|---|---|---|---|---|---|---|---|---|---|---|---|
| | | 0 | 1 | 2 | 3 | 4 | 5 | 6 | 7 | 8 | 9 | 10 | 11 | 12 | 13 | 14 | 15 |
| u | 0 | 52 | 09 | 6a | d5 | 30 | 36 | a5 | 38 | bf | 40 | a3 | 9e | 81 | f3 | d7 | fb |
| | 1 | 7c | e3 | 39 | 82 | 9b | 2f | ff | 87 | 34 | 8e | 43 | 44 | c4 | de | e9 | cb |
| | 2 | 54 | 7b | 94 | 32 | a6 | c2 | 23 | 3d | ee | 4c | 95 | 0b | 42 | fa | c3 | 4e |
| | 3 | 08 | 2e | a1 | 66 | 28 | d9 | 24 | b2 | 76 | 5b | a2 | 49 | 6d | 8b | d1 | 25 |
| | 4 | 72 | f8 | f6 | 64 | 86 | 68 | 98 | 16 | d4 | a4 | 5c | cc | 5d | 65 | b6 | 92 |
| | 5 | 6c | 70 | 48 | 50 | fd | ed | b9 | da | 5e | 15 | 46 | 57 | a7 | 8d | 9d | 84 |
| | 6 | 90 | d8 | ab | 00 | 8c | bc | d3 | 0a | f7 | e4 | 58 | 05 | b8 | b3 | 45 | 06 |
| | 7 | d0 | 2c | 1e | 8f | ca | 3f | 0f | 02 | c1 | af | bd | 03 | 01 | 13 | 8a | 6b |
| | 8 | 3a | 91 | 11 | 41 | 4f | 67 | dc | ea | 97 | f2 | cf | ce | f0 | b4 | e6 | 73 |
| | 9 | 96 | ac | 74 | 22 | e7 | ad | 35 | 85 | e2 | f9 | 37 | e8 | 1c | 75 | df | 6e |
| | 10 | 47 | 11 | 1a | 71 | 1d | 29 | c5 | 89 | 6f | b7 | 62 | 0e | aa | 18 | be | 1b |
| | 11 | fc | 56 | 3e | 4b | c6 | d2 | 79 | 20 | 9a | db | c0 | fe | 78 | cd | 5a | f4 |
| | 12 | 1f | dd | a8 | 33 | 88 | 07 | c7 | 31 | b1 | 12 | 10 | 59 | 27 | 80 | ec | 5f |
| | 13 | 60 | 51 | 7f | a9 | 19 | b5 | 4a | 0d | 2d | e5 | 7a | 9f | 93 | c9 | 9c | ef |
| | 14 | a0 | e0 | 3b | 4d | ae | 2a | f5 | b0 | c8 | eb | bb | 3c | 83 | 53 | 99 | 61 |
| | 15 | 17 | 2b | 04 | 7e | ba | 77 | d6 | 26 | e1 | 69 | 14 | 63 | 55 | 21 | 0c | 7d |

The inverse of the ShiftRows function 140, called InvShiftRows 240, cyclically shifts the bytes of the last three rows of the state S. In particular, for row r of the state S (1≦r<4), the elements of row r are cyclically shifted by r positions to the right, i.e. the application of the InvShiftRows function 240 to S[r,c] sets the value S[r,c] to the value S′[r,c] given by S′[r,c]=S[r,(c-r)(mod 4)](for 0≦r<4 and 0≦c<4). Note that, for 0≦r<4, this is equivalent to cyclically shifting the elements of the r^{th} row (4-r)mod 4 positions to the left.

For the inverse of the MixColumns function 150, called InvMixColumns 250, each column of the state S is processed by multiplying the column by a particular matrix. In particular, for (0≦c<4), the MixColumns function 150 operates on the c^{th} column according to:

$$( \begin{matrix}{S}^{′} [ 0 , c ] \\ {S}^{′} [ 1 , c ] \\ {S}^{′} [ 2 , c ] \\ {S}^{′} [ 3 , c ]\end{matrix} ) = ( \begin{matrix}e & b & d & 9 \\ 9 & e & b & d \\ d & 9 & e & b \\ b & d & 9 & e\end{matrix} ) ( \begin{matrix}S [ 0 , c ] \\ S [ 1 , c ] \\ S [ 2 , c ] \\ S [ 3 , c ]\end{matrix} )$$

where: multiplication by e means shifting to the left, XOR-ing with the initial un-shifted value, shifting to the left again, XOR-ing with the initial un-shifted value, and shifting to the left again; multiplication by b means shifting to the left, shifting to the left again, XOR-ing with the initial un-shifted value, shifting to the left again, and XOR-ing with the initial un-shifted value; multiplication by d means shifting to the left, XOR-ing with the initial un-shifted value, shifting to the left again, shifting to the left again, and XOR-ing with the initial un-shifted value; and multiplication by 9 means shifting to the left, shifting to the left again, shifting to the left again, and XOR-ing with the initial un-shifted value. After a shifting, the shifted value should be XOR-ed with 0x11 B if the shifted value is larger than 0xFF.

Again, a polynomial representation may be used to implement the InvMixColumns 250 function. In particular, the elements of the c^{th} column of the state S may be treated as coefficients of a four-term polynomial over GF(2⁸), with this polynomial then being multiplied modulo x⁴+1 by the polynomial (b)x³+(d)x²+(9)x+(e), where the coefficients of this polynomial are in hexadecimal—the coefficients of the resultant polynomial then form the updated elements of the c^{th} column of the state S.

Thus, decryption of a block of data can be performed by applying the InvAddRoundKey function 220, the InvSubBytes function 230, the InvShiftRows function 240, and the InvMixColumns function 250 in the reserve of the order, set out in FIG. 1, of their counterpart functions, using the same key schedule as for encryption. However, as set out in section 5.3.5 of Federal Information Processing Standards Publication 197, and as shown in the FIG. 2, it is possible to perform decryption 200 of a block of data 210 to form an output block of data 260 using the same order of the functions set out in FIG. 1 (but with the functions in FIG. 1 replaced in FIG. 2 by their inverses), but with the key schedule modified to produce a corresponding decryption key schedule for the purposes of decryption (the round keys for the decryption 200 being denoted RK′_{R} in FIG. 2).

The skilled person will appreciate that any further details for the AES algorithm can be found in Federal Information Processing Standards Publication 197 and that the above description is provided to assist the reader (who is assumed to be knowledgeable about the AES algorithm).

The “data flow transformation” is an important technology for helping to protect software (e.g. a program or an application) from attacks performed by an attacker (who may, for example, wish to obtain secret or sensitive information from the software, such as a cryptographic key). With a data flow transformation, the protection of data and/or operations of the software is implemented by re-writing (or replacing) the whole or a part of the software with new code—the new (replacement) code is generated by performing one or more data and/or operation transformations on the data and/or operations that are to be protected. Such transformations are well-known, and are sometimes referred to as software obfuscation techniques. At present, the new code (generated after applying specific data and/or operation transformations) is fixed inside the new version of the original software. Applying different data transformations to the same data and/or operations of the software should result in different instances or versions of the software that is to be protected. Such diversity (namely different instances of the same software) is called “code-based diversity”. Hence, in order to obtain different diversified instances of the software, the transformation process has to be repeated by applying different data and/or operation transformations to the same software. From the view of software distribution, deployment, and maintenance including security renewability, such code-based diversity introduces unavoidable overhead and inconveniences.

### SUMMARY OF THE INVENTION

It would be desirable to be able to implement the AES algorithm (encryption or decryption) in a manner that is more secure than previous implementations. In particular, it would be desirable to be able to implement the AES algorithm in a manner that is tolerant to changes (either malicious or accidental) to input values to the algorithm or intermediate results of the algorithm or that is tolerant to modifications of the processing flow of the algorithm. Such an implementation would help combat attacks that an attacker may try to carry out on the implementation, and thereby help prevent (or at least make more difficult) the attacker from obtaining or deducing information about cryptographic keys or from accessing, in an unauthorised manner, secured data. This is particularly useful in scenarios in which the implementation of the algorithm is to be a so-called whitebox implementation (such as a software implementation) in which the attacker is assumed to have knowledge of the algorithm and its implementation and is assumed to have access to, and is able to manipulate, the process flow and memory contents of, the implementation as it functions.

According to a first aspect of the invention, there is provided a method of cryptographically processing a block of data, the method comprising: receiving an encoded version of the block of data, wherein the encoded version of the block of data comprises the block of data encoded, at least in part, using an error control code; and processing the encoded version of the block of data using a predetermined function to generate an output, wherein the predetermined function is arranged so that the result of processing, with the predetermined function, a quantity of data encoded, at least in part, using the error control code equals the result of encoding, at least in part, with the error control code the result of performing encryption or decryption of the quantity of data according to the Advanced Encryption Standard, AES.

In some embodiments, the predetermined function comprises one or more sub-functions, wherein each of the sub-functions is arranged so that the result of processing, with that sub-function, a quantity of data encoded, at least in part, using the error control code equals the result of encoding, at least in part, with the error control code the result of processing the quantity of data according to a corresponding processing step of the AES, wherein the corresponding processing step is one of: the AddRoundKey function; the MixColumns function; the ShiftRows function; the SubBytes function; the InvAddRoundKey function; the InvMixColumns function; the InvShiftRows function; the InvSubBytes function.

In some embodiments, the method comprises: using the error control code to detect whether there is an error in one or more of: the received encoded version of the block of data, the output, or an intermediate result of the predetermined function; and if an error is detected, performing a corresponding action. The corresponding action may comprise one of: (a) setting the output to be substantially unrelated to the received encoded version of the block of data; (b) setting the output to be a random value; (c) ceasing performing the predetermined function; and (d) performing an error correction operation of the error control code to correct the error.

In some embodiments, the method comprises: performing a decoding operation of the error control code on the output.

In some embodiments, the encoded version of the block of data and intermediate results of the predetermined function are each represented by corresponding first matrices, wherein each first matrix corresponds to a state matrix that would occur if the encryption or decryption according to the AES were performed on the block of data, wherein each first matrix corresponds to a state matrix in that elements of that first matrix are coefficients of codewords that would result from encoding, with the error control code, messages formed from corresponding elements of the corresponding state matrix. Optionally, for each row or column of each first matrix, the elements of that row or column are coefficients of a codeword that would result from encoding, with the error control code, a message formed from the elements of a corresponding row or column of the corresponding state matrix.

According to an aspect of the invention, there is provided a method of enabling a data processor to cryptographically process a block of data, the method comprising: generating one or more modules which, when executed, carry out any one of the above-described methods; and configuring the data processor to execute the one or more modules.

According to an aspect of the invention, there is provided a method of providing a block of data to an entity arranged to carry out a method according to any one of the preceding claims, comprising: generating an encoded version of the block of data, wherein the encoded version of the block of data comprises the block of data encoded, at least in part, using an error control code; applying a modification to the encoded version of the block of data to form a modified encoded version of the block of data, wherein the modification is such that the error control code can correct the modification to produce the encoded version of the block of data from the modified encoded version of the block of data; and providing the modified encoded version of the block of data to the entity.

According to an aspect of the invention, there is provided an apparatus comprising a processor, wherein the processor is arranged to carry out any one of the above methods.

According to an aspect of the invention, there is provided a computer program which, when executed by a processor, causes the processor to carry out any one of the above methods. The computer program may be stored on a computer readable medium.

With embodiments of the invention, errors may be introduced into encoded data that is provided from an encoder, such that a decoder is able to remove the effect of the error following the processing of the encoded data (with the error) by the second predetermined function. In this way, it is possible to use such errors to control ECC based data transformations. This enhances the level of diversity available in that diversity may be structured into two kinds of diversities: (1) code-based diversity (different diversity comes from providing and executing a different instance of code, where the different instances are generated by applying different transformations to initial, or baseline, code); and (2) data-based diversity (different diversity comes from applying different control data to the same version of diversified code). Therefore, compared to the currently existing purely code-based diversity technology, the use of ECC in accordance with embodiments of the invention provides an effective way of helping increase the amount of diversity available.

Moreover, the use of ECC in accordance with embodiments of the invention provides a method of obfuscating the implementation of a function and provides a mechanism for making it more difficult for an attacker to attack a piece of software (such as by trying to perform fault-injection attacks).

### BRIEF DESCRIPTION OF THE DRAWINGS

Embodiments of the invention will now be described, by way of example only, with reference to the accompanying drawings, in which:

FIG. 1 provides an overview of encryption using the AES algorithm;

FIG. 2 provides an overview of decryption using the AES algorithm;

FIG. 3 schematically illustrates an example of a computer system;

FIG. 4 schematically illustrates an overview of an embodiment of the invention;

FIG. 5 schematically illustrates an overview of a function e*;

FIG. 6 schematically illustrates an approach for implementing a SubBytes* function;

FIG. 7 schematically illustrates an overview of a function d*; and

FIG. 8 schematically illustrates a system according to an embodiment of the invention.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### (1) System Overview

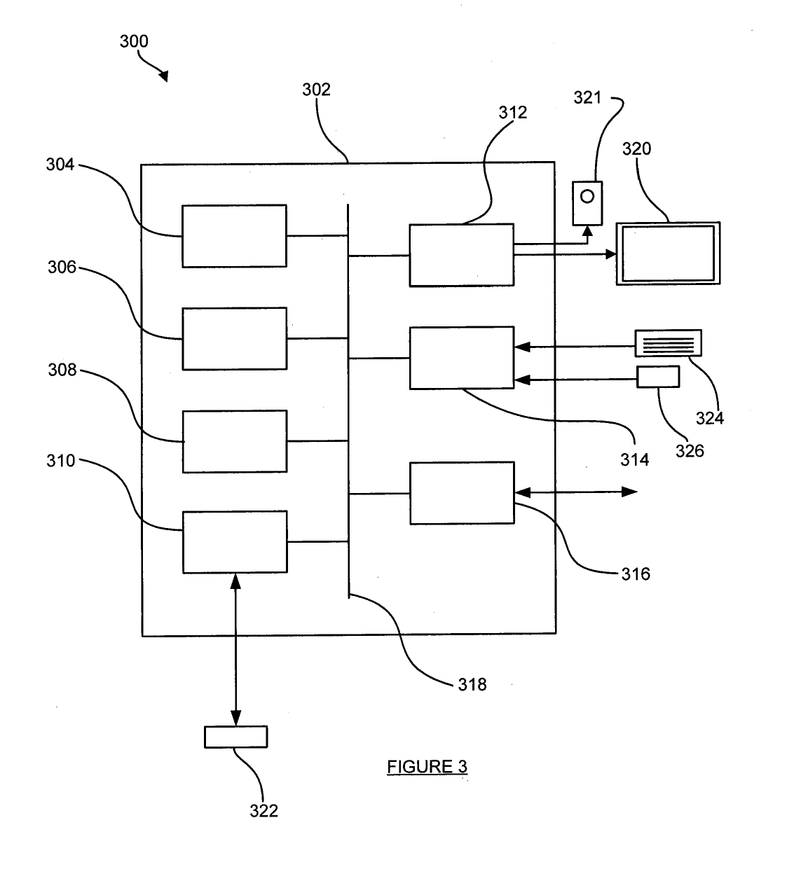

FIG. 3 schematically illustrates an example of a computer system 300. The system 300 comprises a computer 302. The computer 302 comprises: a storage medium 304, a memory 306, a processor 308, a interface 310, a user output interface 312, a user input interface 314 and a network interface 316, which are all linked together over one or more communication buses 318.

The storage medium 304 may be any form of non-volatile data storage device such as one or more of a hard disk drive, a magnetic disc, an optical disc, a ROM, etc. The storage medium 304 may store an operating system for the processor 308 to execute in order for the computer 302 to function. The storage medium 304 may also store one or more computer programs (or software or instructions or code).

The memory 306 may be any random access memory (storage unit or volatile storage medium) suitable for storing data and/or computer programs (or software or instructions or code).

The processor 308 may be any data processing unit suitable for executing one or more computer programs (such as those stored on the storage medium 304 and/or in the memory 306), some of which may be computer programs according to embodiments of the invention or computer programs that, when executed by the processor 308, cause the processor 308 to carry out a method according to an embodiment of the invention and configure the system 300 to be a system according to an embodiment of the invention. The processor 308 may comprise a single data processing unit or multiple data processing units operating in parallel or in cooperation with each other. The processor 308, in carrying out data processing operations for embodiments of the invention, may store data to and/or read data from the storage medium 304 and/or the memory 306.

The interface 310 may be any unit for providing an interface to a device 322 external to, or removable from, the computer 302. The device 322 may be a data storage device, for example, one or more of an optical disc, a magnetic disc, a solid-state-storage device, etc. The device 322 may have processing capabilities—for example, the device may be a smart card. The interface 310 may therefore access data from, or provide data to, or interface with, the device 322 in accordance with one or more commands that it receives from the processor 308.

The user input interface 314 is arranged to receive input from a user, or operator, of the system 300. The user may provide this input via one or more input devices of the system 300, such as a mouse (or other pointing device) 326 and/or a keyboard 324, that are connected to, or in communication with, the user input interface 314. However, it will be appreciated that the user may provide input to the computer 302 via one or more additional or alternative input devices (such as a touch screen). The computer 302 may store the input received from the input devices via the user input interface 314 in the memory 306 for the processor 308 to subsequently access and process, or may pass it straight to the processor 308, so that the processor 308 can respond to the user input accordingly.

The user output interface 312 is arranged to provide a graphical/visual and/or audio output to a user, or operator, of the system 300. As such, the processor 308 may be arranged to instruct the user output interface 312 to form an image/video signal representing a desired graphical output, and to provide this signal to a monitor (or screen or display unit) 320 of the system 300 that is connected to the user output interface 312. Additionally or alternatively, the processor 308 may be arranged to instruct the user output interface 312 to form an audio signal representing a desired audio output, and to provide this signal to one or more speakers 321 of the system 300 that is connected to the user output interface 312.

Finally, the network interface 316 provides functionality for the computer 302 to download data from and/or upload data to one or more data communication networks.

It will be appreciated that the architecture of the system 300 illustrated in FIG. 3 and described above is merely exemplary and that other computer systems 300 with different architectures (for example with fewer components than shown in FIG. 3 or with additional and/or alternative components than shown in FIG. 3) may be used in embodiments of the invention. As examples, the computer system 300 could comprise one or more of: a personal computer; a server computer; a mobile telephone; a tablet; a laptop; a television set; a set top box; a games console; a personal computer; a server computer; other mobile devices or consumer electronics devices; a smart card; etc.

### (2) Algorithm Overview

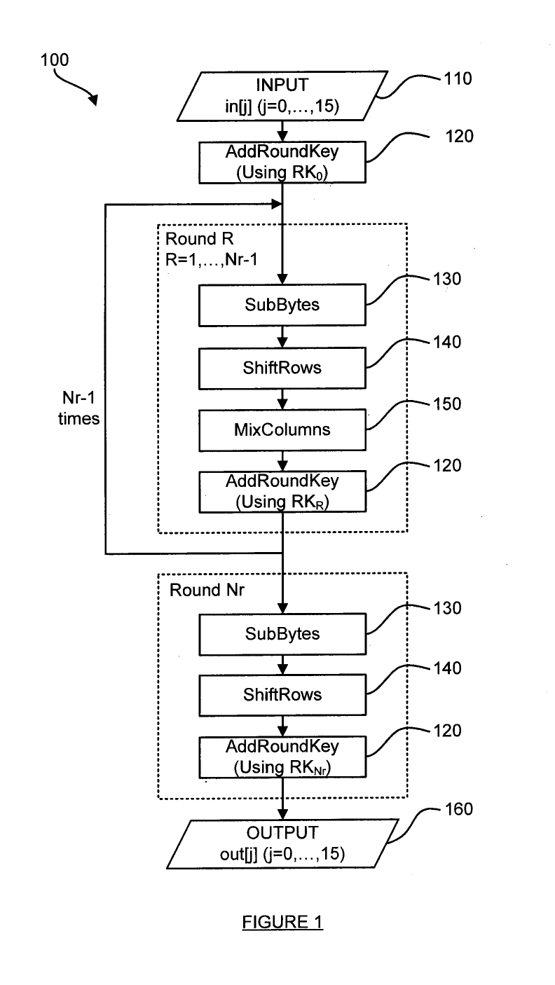

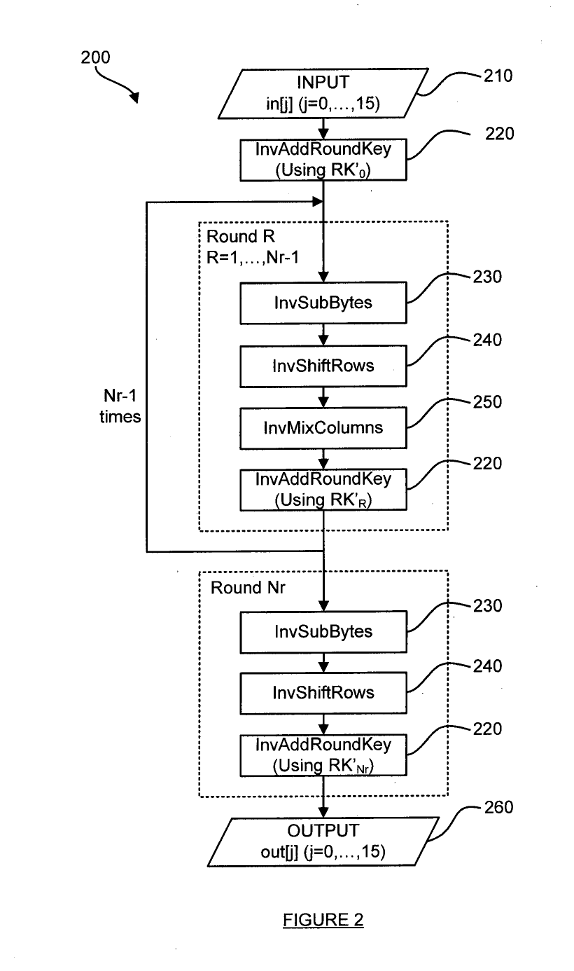

Let the function “e” represent the encryption processing performed according to the AES algorithm as described above with reference to FIG. 1, and let the function “d” represent the decryption processing performed according to the AES algorithm, as described above with reference to FIG. 2. Given a block of data D of size 128 bits, the result of performing AES encryption on the block of data D using a key K is therefore represented by the block of data e(D,K), and the result of performing AES decryption on the block of data D using a key K is therefore represented by the block of data d(D,K). Let φ represent an ECC, so that the result of performing ECC encoding on the block of data D using the ECC φ is represented by the block of data φ(D) (which will be larger than the block of data D). Then, as shall be described in more detail below, in one embodiment of the invention, there is provided a function “e*” which has, as its inputs, a codeword of the ECC φ and a key K, and which is arranged such that e*(φ(D),K)=φ(e(D,K)) for all blocks of data D and keys K. In another embodiment of the invention, there is provided a function “d*” which has, as its inputs, a codeword of the ECC φ and a key K, and which is arranged such that d*(φ(D),K)=φ(d(D,K)) for all blocks of data D.

In other words, for an ECC encoded version φ(D) of the block of data D (wherein the encoded version φ(D) of the block of data D comprises the block of data D encoded, at least in part, using an ECC φ), that ECC encoded version φ(D) of the block of data D may be processed using a predetermined function e* or d* to generate an output. The predetermined function e* or d* is arranged so that the result of processing, with the predetermined function e* or d*, a quantity of data A encoded, at least in part, using the ECC φ equals the result of encoding, at least in part, with the ECC φ the result of processing the quantity of data A according to the Advanced Encryption Standard, AES (namely e(A,K) or d(A,K))—i.e. d*(φ(A,K))=φ(d(A,K)) and e*(φ(A,K))=D(e(A,K)).

This means that, given an ECC encoded version φ(D) of the block of data D, the function e* or d* may be applied to the encoded version φ(D) of the block of data D to thereby generate e*(φ(D),K) or d*(φ(D),K). Decoding of e*(φ(D),K) or d*(φ(D),K) using the ECC φ results in e(D,K) or d(D,K) respectively. Thus, the ECC φ is made “transparent” to the AES algorithm. In other words, the functions e* and d*, when provided with an ECC encoded version φ(D) of the block of data D as an input, output a result that would have resulted from performing the encryption processing e or the decryption processing d on the block of data D and then performing ECC encoding on the processed block of data D. One advantage of using the functions e* and d* is that, given an ECC encoded version φ(D) of the block of data D, if one wishes to form an ECC encoded version of the corresponding encrypted or decrypted form of the block of data D (i.e. an ECC encoded version of e(D,K) or d(D,K)) then one can simply use the functions e* and d*, i.e. one does not need to (a) perform ECC decoding on the input ECC encoded version φ(D) of the block of data D, (b) perform the encryption or decryption processing using the function e or d, and (c) perform ECC encoding on the output of the encryption or decryption processing. This can reduce the processing requirements, the power requirements, and the time needed to carry out the processing.

Moreover, as shall be described shortly, intermediate results (or the intermediate state) of the functions e* and d* are codewords of the ECC φ and the presence of errors in the intermediate results can, therefore, be tested using the ECC φ. The initial input ECC encoded version φ(D) of the block of data D and/or the output of the functions e* and d* can additionally or alternatively be tested for errors using error detection/correction capabilities or properties of the ECC φ. If an error is detected in one or more of: the received ECC encoded version of the block of data D, the output, or an intermediate result of the predetermined functions e* and d*, then appropriate action may be taken. This action may include setting the output of the functions e* and d* to be substantially unrelated to the received ECC encoded version φ(D) of the block of data D. For example, the output may be set to be a random value. Another action may include the function e* or d* stopping (in an incomplete state), i.e. ceasing to operate. Another action may be to use error correcting capabilities of the ECC (if the ECC is an error correcting code) to correct any detected errors. Thus, another advantage of using the functions e* and d* is that, in doing so, it is possible to detect deliberate or accidental introduction of faults into the input, output or intermediate results of the processing and/or detect changes to processing flow of the functions e* and d*—if such faults or changes are detected, then appropriate measures may then be taken as discussed above.

An additional advantage is that embodiments of the invention can increase the “diversity” available to the sender of the data that is to be encrypted or decrypted. In particular, if encryption or decryption of an amount of data is performed by a first entity (e.g. a client), then a second entity (e.g. a server) might send to the first entity an ECC encoded version of the original data together with an amount of noise added to the ECC encoded data. In other words, the second entity may apply a modification to the ECC encoded data so as to produce modified ECC encoded data. As the second entity can add a large number of different noise patterns to the ECC encoded data without preventing the ECC decoding from being able recover the original data, the second entity can send the same original data to the first entity in a secured manner in a larger number of ways, i.e. by sending the ECC encoded original data with one of a large number of available noise patterns added or modifications made (where the noise pattern only adds errors that are correctable by the ECC decoding, or, equivalently, the modification is such that the ECC can correct the modification to produce, or restore, the ECC encoded data from the modified ECC encoded data). An eavesdropper/attacker would not know whether or not noise had been added, let alone what the noise pattern might actually be, thereby making it more difficult for the eavesdropper/attacker to access the original data.

In the context of software protection, such diversity introduces new capabilities that are of real importance. As mentioned, current methods of introducing diversity involve re-writing the software so that the data and/or operations are transformed, and diversity is introduced inside the software by using different transformations for different instances of the software. However, once an instance of the software is created and distributed, its diversity cannot subsequently be changed. Issuing a new version of the software involves generating the new version using new transformations, which introduces delay, various overhead and other inconveniences. However, with embodiments of the invention, the addition of error (as the diversity) can be added independent of the software. The error may or may not depend on the input data as per the requirement of the application. Moreover, the design parameters, such as the generator polynomial, can be made dependent on the input data (provided that the entity that performs the ECC encoding and the entity that performs the ECC decoding are arranged to determine and use the same design parameters, such as the generator polynomial).

Thus, embodiments of the invention provide useful implementations of the AES encryption or decryption processing—i.e. implementations in which AES encryption or decryption processing is performed, but combined with the advantages of using an ECC.

In general, for a function F that operates on a block of data D, we shall call the function F* the corresponding “transformed function” if φ(F(D))=F*(φ(D)) for all blocks of data D (of the relevant size for input to the function F). Thus, for any given key K, the function e* is the transformed function corresponding to the AES encryption function e, and the function d* is the transformed function corresponding to the AES decryption function d.

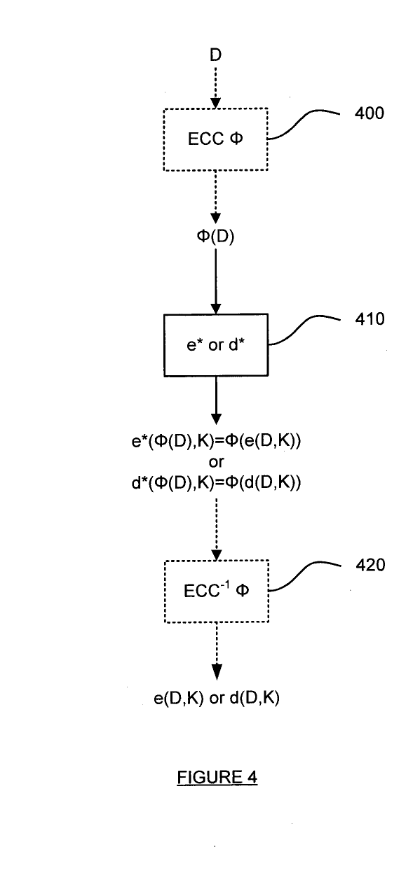

FIG. 4 schematically illustrates an overview of an embodiment of the invention which may be carried out, for example, by the processor 308 of the system 300.

At an optional step 400, an initial block of data D (of size 128 bits) may be encoded using the ECC φ, to produce an encoded version φ(D) of the block of data D. The initial block of data D may be received, for example, via the interface 310, the user input interface 314 or the network interface 316. Additionally or alternatively, the initial block of data D may already be stored by the system 300 in the storage medium 304 or the memory 306.

The step 400 is an optional step as the system 300 may already be storing (for example in the storage medium 304 or the memory 306), or may have already received (for example via the interface 310, the user input interface 314 or the network interface 316), the encoded version φ(D) of the block of data D rather than having to perform the ECC encoding itself.

Next, at a step 410, the function e* or d* is applied to the encoded version φ(D) of the block of data D, using a key K, to produce e*(φ(D),K) or d*(φ(D),K) as an output. This output may be stored, for example, in the storage medium 304 or the memory 306, or may be output from the computer 302, for example via the interface 310, the user output interface 312 or the network interface 316.

Note that, due to the nature of the functions e* and d*, e*(φ(D),K)=φ(e(D,K)) and d*(φ(D(D),K)=φ(d(D,K)). Thus, at an optional step 420, the output may undergo ECC decoding using the ECC φ, which results in e(D,K) or d(D,K). The decoded data e(D,K) or d(D,K) may be stored, for example, in the storage medium 304 or the memory 306, or may be output from the computer 302, for example via the interface 310, the user output interface 312 or the network interface 316.

More details of the operations carried out in embodiments of the invention are set out below.

(2.1) ECC encoding and decoding

For the AES algorithm, the state S is the matrix

$$S = [ \begin{matrix}S [ 0 , 0 ] & S [ 0 , 1 ] & S [ 0 , 2 ] & S [ 0 , 3 ] \\ S [ 1 , 0 ] & S [ 1 , 1 ] & S [ 1 , 2 ] & S [ 1 , 3 ] \\ S [ 2 , 0 ] & S [ 2 , 1 ] & S [ 2 , 2 ] & S [ 2 , 3 ] \\ S [ 3 , 0 ] & S [ 3 , 1 ] & S [ 3 , 2 ] & S [ 3 , 3 ]\end{matrix} ]$$

The initial block of data D, of 128 bits, received or accessed at the step 400 of FIG. 4 may be formatted into a state matrix S in the manner discussed above for the AES algorithm.

For the encoding performed at the step 400, each of the four rows of the matrix S is considered to be a four-element message. ECC encoding is then applied to each of these four messages. In particular, the r^{th} row of the matrix S corresponds to the message mᵣ(X), where mᵣ(X)=S[r,3]X³+S[r,2]X²+S[r,1]X+S[r,0](although it will be appreciated that other ways of mapping the elements of the r^{th} row of the state S to coefficients of the message mᵣ(X) could be used instead, for example one could set mᵣ(X)=S[r,0]X³+S[r,1]X²+S[r,2]X+S[r,3]). The messages mᵣ(X)(0≦r<4) are then each encoded using a polynomial ECC with a generator polynomial g(X) to form a corresponding codeword cᵣ(X), where cᵣ(X)=mᵣ(X)g(X). In this embodiment, non-systematic encoding is being used as an example, but it will be appreciated that systematic encoding, or other encoding methods for the ECC could be used instead. Assume that the degree of g(X) is w, then the codewords cᵣ(X) are of degree up to w+3. A transformed state S* is then formed, which is a 4x(w+4) matrix, where the elements of the r^{th} row of the state S* are the coefficients of the codeword cᵣ(X). For example, if w=2, so that g(X)=g₀+g₁X+X², the state S is mapped to a transformed state S* according to

$$S = [ \begin{matrix}S [ 0 , 0 ] & S [ 0 , 1 ] & S [ 0 , 2 ] & S [ 0 , 3 ] \\ S [ 1 , 0 ] & S [ 1 , 1 ] & S [ 1 , 2 ] & S [ 1 , 3 ] \\ S [ 2 , 0 ] & S [ 2 , 1 ] & S [ 2 , 2 ] & S [ 2 , 3 ] \\ S [ 3 , 0 ] & S [ 3 , 1 ] & S [ 3 , 2 ] & S [ 3 , 3 ]\end{matrix} ] -> [ \begin{matrix}S [ 0 , 0 ] & S [ 0 , 1 ] & S [ 0 , 2 ] & S [ 0 , 3 ] & S [ 0 , 4 ] & S [ 0 , 5 ] \\ S [ 1 , 0 ] & S [ 1 , 1 ] & S [ 1 , 2 ] & S [ 1 , 3 ] & S [ 1 , 4 ] & S [ 1 , 5 ] \\ S [ 2 , 0 ] & S [ 2 , 1 ] & S [ 2 , 2 ] & S [ 2 , 3 ] & S [ 2 , 4 ] & S [ 2 , 5 ] \\ S [ 3 , 0 ] & S [ 3 , 1 ] & S [ 3 , 2 ] & S [ 3 , 3 ] & S [ 3 , 4 ] & S [ 3 , 5 ]\end{matrix} ] = {S}^{*}$$

where cᵣ(X)=c[r,5]X⁵+c[r,4]X⁴+c[r,3]X³+c[r,2]X²+c[r,1]X+c[r,0]. Again, it will be appreciated that the coefficients of the codeword cᵣ(X) may be mapped to different element positions of the r^{th} row of the transformed state S*.

In the following, it shall be assumed that the generator polynomial is a polynomial g(X)=g₀+g₁X+X² of degree 2, although it will be appreciated that other degrees could be used instead for the ECC generator polynomial g(X).

The initial ECC encoded block of data, φ(D), formed at the optional step 400, or received as an input to the step 410, is therefore the transformed state S* that is produced by the above ECC encoding of the state S, where the state S corresponds to the initial block of data D.

The functions e* and d* then operate on a transformed state S*—i.e. the input to, output from, and intermediate results of the functions e* and d* are respective 4x(w+4) matrices (i.e. transformed state matrices S*), each element of which is a byte.

For the decoding performed at the step 420, each of the four rows of the transformed state matrix S* output from the function e* or d* at the step 410 is considered to be a codeword of the ECC, and the corresponding ECC decoding operation is performed on these codewords. This results in four messages of length four bytes. The bytes of these four messages are mapped back to a state matrix S (using the mapping that was employed for the encoding performed at the step 400). An output block of data D may then be formed from this state matrix S in the manner discussed above for the AES algorithm.

It will be appreciated that any polynomial ECC may be used for the above ECC encoding and decoding.

### (2.1.1) Detecting Errors

As mentioned above, intermediate results (or the intermediate state) of the functions e* and d* comprise codewords of the ECC φ—in particular, the intermediate results of the functions e* and d* are transformed state matrices whose rows represent respective codewords of the ECC. Similarly, the initial input ECC encoded version φ(D) of the block of data D to, and the output of, the functions e* and d* are transformed state matrices whose rows represent respective codewords of the ECC. Thus, one or more of these codewords (of the intermediate results of, or of the input to or output from, the function e* or d*) can be tested to detect whether or not an error exists in that codeword. As discussed above, if an error is detected, then appropriate action may be taken.

The usual error detection property/operation/processing of the ECC can be used for this detection.

Alternatively, instead of carrying out the full error detection processing of the ECC, a reduced error detection processing can be performed. For example, if the codeword polynomial c(X)=c₀+c₁X+c₂X²+c₃X³+c₄X⁴+c₅X⁵ corresponds to the message polynomial m(X)=a₀+a₁X+a₂X²+a₃X³, then

$$\begin{matrix}c ( X ) = g ( X ) m ( X ) \\ = {g}_{0} {a}_{0} + ( {g}_{0} {a}_{1} + {g}_{1} {a}_{0} ) X + ( {g}_{0} {a}_{2} + {g}_{1} {a}_{1} + {a}_{0} ) {X}^{2} + \\ ( {g}_{0} {a}_{3} + {g}_{1} {a}_{2} + {a}_{1} ) {X}^{3} + ( {g}_{1} {a}_{3} + {a}_{2} ) {X}^{4} + {a}_{3} {X}^{5} \\ = {c}_{0} + {c}_{1} X + {c}_{2} {X}^{2} + {c}_{3} {X}^{3} + {c}_{4} {X}^{4} + {C}_{5} {X}^{5}\end{matrix}$$

Thus, in the absence of errors in c(X):

c₀=g₀a₀

c₁=(g₀a₁+g₁a₀)

c₂=(g₀a₂+g₁a₁+a₀)

c₃=(g₀a₃+g₁a₂+a₁)

c₄=(g₁a₃+a₂)

c₅=a₃ (Equations A)

Equations A above provide six equations in four unknowns a₀, a₁, a₂, a₃. It is, therefore, possible to derive multiple sets of equations that define a₀, a₁, a₂, a₃ in terms of the codeword coefficients c₀, . . . , c₅. For example, define:

f₀(c₀)=c₀g₀⁻¹

f₁(c₀,c₁)=(c₁+c₀g₀⁻¹g₁)g₀⁻¹

f₂(c₀,c₁,c₂)=(c₂+c₀g₀⁻¹+(c₁+c₀g₀⁻¹g₁)g₀⁻¹g₁)g₀⁻¹

f₃(c₁,c₂,c₃)=(c₃+(c₁+c₀g₀⁻¹g₁)g₀⁻¹+(c₂+c₀g₀⁻¹+(c₁+c₀g₀⁻¹g₁)g₀⁻¹g₁)g₀⁻¹g₁)g₀⁻¹

f′₂(c₄,c₅)=c₄+c₅g₁

f′₁(c₃,c₄,c₅)=c₃+g₀c₅+g₁(c₄+c₅g₁)

f′₀(c₂,c₃,c₄,c₅)=c₂+g₀(c₄+c₅g₁)+g₁(c₃+g₀c₅+g₁(c₄+c₅g₁)) (Equations B)

Then Equations A and B imply that:

c₀=g₀a₀ [symbol] f₀(c₀)=a₀

c₁=(g₀a₁+g₁a₀) [symbol] f₁(c₀,c₁)=a₁

c₂=(g₀a₂+g₁a₁+a₀) [symbol] f₂(c₀,c₁,c₂)=a₂

c₃=(g₀a₃+g₁a₂+a₁) [symbol] f₃(c₁,c₂,c₃)=a₃ (Equations C)

Equations A and B also imply that:

c₅=a₃

c₄=(g₁a₃+a₂) [symbol] f′₂(c₄,c₅)=a₂

c₃=(g₀a₃+g₁a₂+a₁) [symbol] f′₁(c₃,c₄,c₅)=a₁

c₂=(g₀a₂+g₁a₁+a₀) [symbol] f′₀(c₂,c₃,c₄,c₅)=a₀ (Equations D)

Thus, the coefficients of the original message m(X) may be deduced from the codeword polynomial c(X) in two ways, namely by: (a) using the functions f₀(c₀), f₁(c₀,c₁), f₂(c₀,c₁,c₂) and f₃(c₁,c₂,c₃) as the coefficients a₀, a₁, a₂ and a₃ of the message m(X) respectively; and (b) using the functions f′₀(c₂,c₃,c₄,c₅), f′₁(c₃,c₄,c₅), and f′₂(c₄,c₅) and the value c₅ as the coefficients a₀, a₁, a₂ and a₃ of the message m(X) respectively. Thus, one can perform one or more of the following tests: (a) does f₀(c₀) equal f′₀(c₂,c₃,c₄,c₅)?(b) does f₁(c₀,c₁) equal f′₁(c₃,c₄,c₅)?(c) does f₂(c₀,c₁,c₂) equal f′₂(c₄,c₅)?(d) does f₃(c₁,c₂,c₃) equal c₅? If inequality is found in any of these tests, then an error in the codeword c(X) is detected.

It will be appreciated that other sets of equations for the coefficients a₀, a₁, a₂, a₃ in terms of the codeword coefficients c₀, . . . , c₅ can be derived from Equations A, so that different tests can be used in addition or alternatively. For example, one could test whether c₂ equals c₀g₀⁻+(c₁+c₀g₀⁻¹g₁)g₀⁻¹g₁+(c₄+c₅g₁)g₀, and/or one could test whether c₃ equals (c₁+c₀g₀⁻¹g₁)g₀⁻¹+(c₄+c₅g₁)g₁+c₅g₀.

It will be appreciated that if the generator polynomial g(X) is of degree greater than 2, then corresponding equations for coefficients a₀, a₁, a₂, a₃ in terms of the codeword coefficients can be derived and used for error detection.

Thus, in some embodiments of the invention, one or more of the codewords (of the intermediate results of, or of the input to or output from, the function e* or d*) can be tested to detect whether or not an error exists in that codeword. This may be carried out using one or more of the above tests.

### (2.2) Function e*

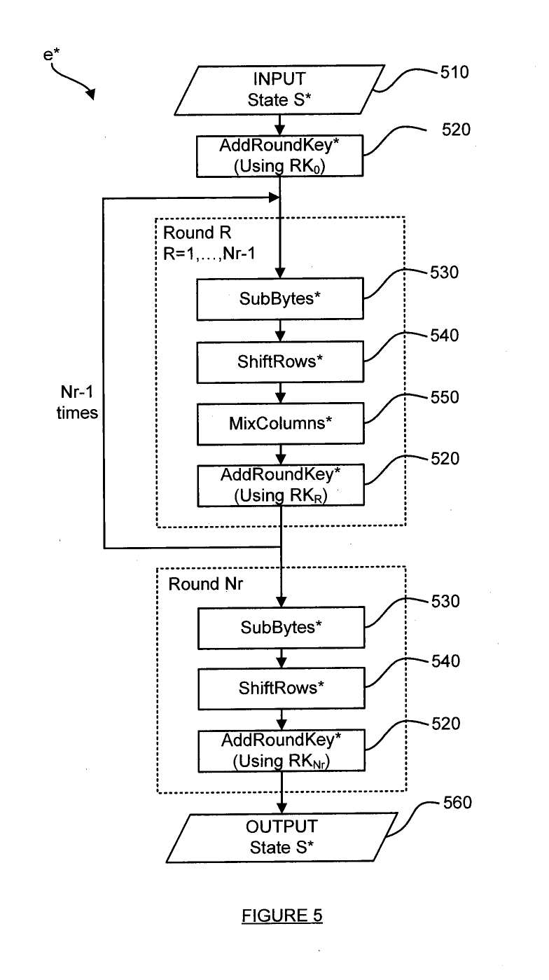

FIG. 5 schematically illustrates an overview of the function e*. The function e* operates in exactly the same way as the AES encryption 100 shown in FIG. 1, except that the input to the function e*, the output of the function e* and the intermediate results of the function e* are transformed state matrices (of size 4x(w+4)), and the functions AddRoundKey 120, SubBytes 130, ShiftRows 140, and MixColumns 150 are replaced by corresponding transformed versions of those functions, namely an AddRoundKey* function 520, a SubBytes* function 530, a ShiftRows* function 540, and a MixColumns* function 550 respectively. Each of the AddRoundKey* function 520, SubBytes* function 530, ShiftRows* function 540 and MixColumns* function 550 operates on a transformed state matrix S* and outputs a transformed state matrix S*. These functions are described in more detail shortly.

If the AddRoundKey* function 520 is represented as a function F*, and the AddRoundKey function 120 is represented as a corresponding function F, then F and F* are related in that φ(F(D))=F*(φ(D)) for all blocks of data D. (Note here that the round key RK is not represented in the above equation—if this were to be included, then we would have φ(F_{RK}(D))=F_{RK}*(φ(D)) for all blocks of data D and all round keys RK). Thus, the AddRoundKey* function 520 is a transformed function corresponding to the AddRoundKey function 120. Similarly, if the SubBytes* function 530 (or the ShiftRows* function 540 or the MixColumns* function 550) is represented as a function F*, and the SubBytes function 130 (or the ShiftRows function 140 or the MixColumns function 150) is represented as a corresponding function F, then F and F* are related in that φ(F(D))=F*(φ(D)) for all blocks of data D. Thus, the SubBytes* function 530 is a transformed function corresponding to the SubBytes function 130; the ShiftRows* function 540 is a transformed function corresponding to the ShiftRows function 140; and the MixColumns* function 550 is a transformed function corresponding to the MixColumns function 150. This will be shown shortly.

Note that if F₁ and F₂ are two functions which have corresponding transformed functions F₁* and F₂* (so that φ(F₁(D))=F₁*φ(D)) and φ(F₂(D))=F₂*(φ(D)) for all blocks of data D), then the transformed function corresponding to the function F₁∘F₂ is the function F₁*∘F₂*. This is because:

$$\begin{matrix}{F}_{1}^{*} ∘ {F}_{2}^{*} = {F}_{1}^{*} ( {F}_{2}^{*} ( Φ ( D ) ) \\ = {F}_{1}^{*} ( Φ ( {F}_{2} ( D ) ) \\ = Φ ( {F}_{1} ( {F}_{2} ( D ) ) \\ = Φ ( {F}_{1} ∘ {F}_{2} ( D ) )\end{matrix}$$

Thus, as the function e* is a concatenation of AddRoundKey* functions 520, SubBytes* functions 530, ShiftRows* functions 540, and MixColumns* functions 550 in the order shown in FIG. 5 (which corresponds to the order shown in FIG. 1), it follows from the above that the function e* is the transformed function corresponding to the function e, i.e. the function e* has the property that φ(e(D))=e*(φ((D)) for all blocks of data D.

### (2.2.1) AddRoundKey*

The r^{th} row of the state S is represented by the message mᵣ(X)=S[r,3]X³+S[r,2]X²+S[r,1]X+S[r,0] and cᵣ(X) is the result of ECC encoding the message mᵣ(X). If the round key RK_{R} for the R^{th} round is a series of bytes k_{R}[j](0≦j<16), then under the AddRoundKey function 120, the element S[r,c] of the state S is XOR-ed with byte k_{R}[r+4c](0≦r<4 and 0≦c<4), so that the element S[r,c] of the state S becomes S′[r,c]=S[r,c]⊕k_{R}[r+4c]. Thus, the message mᵣ(X) would be transformed under the AddRoundKey function 120 to become the message m′_{R,r}(X) where

m′_{R,r}(X)=(S[r,0]⊕k_{R}[r])+(S[r,1]⊕k_{R}[r+4])X+(S[r,2]⊕k_{R}[r+8])X²+(S[r,3]⊕k_{R}[r+12])X³

Let q_{R,r}(X)=k_{R}[r]+k_{R}[r+4]X+k_{R}[r+8]X²+k_{R}[r+12]X³. Let the result of ECC encoding q_{R,r}(X) be \tilde{c}_{R,r}(X)=g(X)q_{R,r}(X).

Then, the result, represented as c′_{R,r}(X), of ECC encoding the r^{th} row of the state S after the AddRoundKey function 120 has been applied to the state S using the R^{th} round key, is:

$$\begin{matrix}{c}_{R , r}^{′} ( X ) = g ( X ) {m}_{R , r}^{′} ( X ) \\ = g ( X ) ( \begin{matrix}\begin{matrix}( S [ r , 0 ] ⊕ {k}_{R} [ r ] ) + \\ ( S [ r , 1 ] ⊕ {k}_{R} [ r + 4 ] ) X +\end{matrix} \\ \begin{matrix}( S [ r , 2 ] ⊕ {k}_{R} [ r + 8 ] ) {X}^{2} + \\ ( S [ r , 3 ] ⊕ {k}_{R} [ r + 12 ] ) {X}^{3}\end{matrix}\end{matrix} ) \\ = ( g ( X ) {m}_{r} ( X ) ) ⊕ ( g ( X ) {q}_{R , r} ( X ) ) \\ = {c}_{r} ( X ) ⊕ {\tilde{c}}_{R , r} ( X )\end{matrix} \qquad ( Equation E )$$

Hence, the result c′_{R,r}(X) of ECC encoding the r^{th} row of the state S after the AddRoundKey function 120 has been applied to the state S using the R^{th} round key may be calculated directly (i) from the result cᵣ(X) of ECC encoding the r^{th} row of the state S and (ii) the result \tilde{c}_{R,r}(X) of ECC encoding the corresponding bytes q_{R,r}(X) of the R^{th} round key using Equation E above.

Thus, if the input to the AddRoundKey* function 520 is a transformed state matrix S having codewords cᵣ(X) (0≦r<4) as its rows, then the output of the AddRoundKey* function 520, when using the R^{th} round key, is defined as a transformed state matrix S* having codewords c′_{R,r}(X) (0≦r<4) as its rows, where c′_{R,r}(X) is calculated using Equation E above, i.e. c′_{R,r}(X)=cᵣ(X)⊕\tilde{c}_{R,r}(X). Note that the values \tilde{c}_{R,r}(X) may be precomputed for a given round key RK_{R}, or they may be generated as part of the key expansion routine that generates the key schedule.

Thus, if the AddRoundKey* function 520 is represented as a function F*, and the AddRoundKey function 120 is represented as a corresponding function F, then F and F* are related in that φ(F(D,RK))=F*(φ(D),RK) for all blocks of data D and all round keys RK. Thus, the AddRoundKey* function 520 is a transformed function corresponding to the AddRoundKey function 120.

### (2.2.2) ShiftRows*

Consider the message m(X)=a₀+a₁X+a₂X²+a₃X³. The result of applying a cyclic shift of one position to the left to the message m(X) is the message m⁽¹⁾(X), where m⁽¹⁾(X)=a₁+a₂X+a₃X²+a₀X³. Let the result of encoding m⁽¹⁾(X) be represented as c′(X), then:

$$\begin{matrix}\begin{matrix}{c}^{′} ( X ) = g ( X ) {m}^{( 1 )} ( X ) \\ = {g}_{0} {a}_{1} + ( {g}_{0} {a}_{2} + {g}_{1} {a}_{1} ) X + ( {g}_{0} {a}_{3} + {g}_{1} {a}_{2} + {a}_{1} ) {X}^{2} + \\ ( {g}_{0} {a}_{0} + {g}_{1} {a}_{3} + {a}_{2} ) {X}^{3} + ( {g}_{1} {a}_{0} + {a}_{3} ) {X}^{4} + {a}_{0} {X}^{5} \\ = ( {g}_{0} {a}_{1} + {g}_{1} {a}_{0} ) + ( {g}_{0} {a}_{2} + {g}_{1} {a}_{1} + {a}_{0} ) X + \\ ( {g}_{0} {a}_{3} + {g}_{1} {g}_{2} + {a}_{1} ) {X}^{2} + ( {g}_{1} {a}_{3} + {a}_{2} ) {X}^{3} {a}_{3} {X}^{4} + \\ {a}_{0} ( {g}_{1} + X ) + {a}_{0} {X}^{3} ( {g}_{0} + {g}_{1} X + {X}^{2} ) \\ = {c}^{( ← )} ( X ) + {a}_{0} {g}^{( ← )} ( X ) + {a}_{0} {X}^{3} g ( X ) \\ = {c}^{( ← )} ( X ) + {c}_{0} {g}_{0}^{- 1} {g}^{( ← )} ( X ) + {c}_{0} {g}_{0}^{- 1} {X}^{3} g ( X )\end{matrix} & ( Equation F ) \\ because {a}_{0} = {c}_{0} {g}_{0}^{- 1} & \end{matrix}$$

In Equation F above, the notation (←) is used as follows: for a polynomial

$$p ( X ) = {\sum }_{i = 0}^{d} {p}_{i} {X}^{i} , {p}^{( ← )} ( X )$$

represents a polynomial whose coefficients are a left shift of the coefficients of p(X),

$$i . e . {p}^{( ← )} ( X ) = {\sum }_{i = 1}^{d} {p}_{i - 1} {X}^{i} .$$

Hence, the result c′(X) of ECC encoding the message m⁽¹⁾(X) may be calculated directly (i) from the result c(X) of ECC encoding the message m(X) and (ii) the generator polynomial g(X).

Naturally, if m^{(s)}(X) is the result of applying the cyclic shift of s positions to the left to the message m(X), wherein s>0, then the result of ECC encoding m^{(s)}(X) may be calculated directly (i) from the result of ECC encoding the message m^{(s-1)}(X) and (ii) the generator polynomial g(X) using the above (where m⁽⁰⁾(X)=m(X)). This may be repeated iteratively s times, so that the result of ECC encoding m^{(s)}(X) may be calculated directly (i) from the result c(X) of ECC encoding the message m(X) and (ii) the generator polynomial g(X).

Thus, if the r^{th} row of the state S is represented by the message mᵣ(X)=S[r,0]+S[r,1]X+S[r,2]X²+S[r,3]X³ (0≦r<4), and if the result of ECC encoding the message mᵣ(X) is the message cᵣ(X), then the result of ECC encoding the r^{th} row of the state S after the ShiftRows function 130 has been applied to the state S may be calculated directly (i) from the result cᵣ(X) of ECC encoding the r^{th} row of the state S and (ii) the generator polynomial g(X), by applying the Equation F iteratively r times (because the r^{th} row of the state matrix S is shifted left r positions under the ShiftRows function 130).

Thus, if the input to the ShiftRows* function 540 is a transformed state matrix S* having codewords cᵣ(X) (0≦r<4) as its rows, then the output of the ShiftRows* function 540 is defined as a transformed state matrix S* having codewords c′ᵣ(X) (0≦r<4) as its rows, where c′ᵣ(X) can be calculated using by applying the Equation F iteratively to the codeword cᵣ(X) r times.

Thus, if the ShiftRows* function 540 is represented as a function F*, and the ShiftRows function 140 is represented as a corresponding function F, then F and F* are related in that φ(F(D))=F*(φ(D)) for all blocks of data D. Thus, the ShiftRows* function 540 is a transformed function corresponding to the ShiftRows function 140.

### (2.2.3) MixColumns

Let an initial message m(X) be m(X)=a₀+a₁X+a₂X²+a₃X³ and let c(X) be the result of ECC encoding the message m(X) using the generator polynomial g(X)=g₀+g₁X+X². Then:

$$\begin{matrix}c ( X ) = g ( X ) m ( X ) \\ = {g}_{0} {a}_{0} + ( {g}_{0} {a}_{1} + {g}_{1} {a}_{0} ) X + ( {g}_{0} {a}_{2} + {g}_{1} {a}_{1} + {a}_{0} ) {X}^{2} + \\ ( {g}_{0} {a}_{3} + {g}_{1} {a}_{2} + {a}_{1} ) {X}^{3} + ( {g}_{1} {a}_{3} + {a}_{2} ) {X}^{4} + {a}_{3} {X}^{5} \\ = {c}_{0} + {c}_{1} X + {c}_{2} {X}^{2} + {c}_{3} {X}^{3} + {c}_{4} {X}^{4} + {c}_{5} {X}^{5}\end{matrix} \qquad ( Equation G )$$

and we have, from Equations C and D, that

a₀=c₀g₀⁻¹

a₁=(c₁+c₀g₀⁻¹g₁)g₀⁻¹

a₃=c₅

a₂=c₄+g₁c₅ (Equations H)

Define functions t₀, t₁, t₂ and t₃ as:

t₀(α,β,γ,δ)=2α+3β+γ+δ

t₁(α,β,γ,δ)=α+2β+3γ+δ

t₂(α,β,γ,δ)=α+β2γ+3δ

t₃(α,β,γ,δ)=3α+β+γ+2δ (Equations I)

Then, for 0≦r<4 and 0≦c<4, the result, S′[r,c], of applying the MixColumns function 140 to the element S[r,c] of the state S is tᵣ(S[0, c],S[1,c],S[2,c],S[3,c]).

Thus, if the r^{th} row of the state S is represented by the message mᵣ(X)=S[r,0]+S[r,1]X+S[r,2]X²+S[r,3]X³ then the r^{th} row of the state S after applying the MixColumns function 140 is represented by the message m′ᵣ(X) where

m′ᵣ(X)=tᵣ(S[0,0],S[1,0],S[2,0],S[3,0])+tᵣ(S[0,1],S[1,1],S[2,1],S[3,1])X+tᵣ(S[0,2],S[1,2],S[2,2],S[3,2])X²+tᵣ(S[0,3],S[1,3],S[2,3],S[3,3])X³

Then, using Equation G above, the result of ECC encoding m′ᵣ(X) is c′ᵣ(X) where

$${c}_{r}^{′} ( X ) = {t}_{r} ( S [ 0 , 0 ] , S [ 1 , 0 ] , S [ 2 , 0 ] , S [ 3 , 0 ] ) {g}_{0} + ( {t}_{r} ( S [ 0 , 1 ] , S [ 1 , 1 ] , S [ 2 , 1 ] , S [ 3 , 1 ] ) {g}_{0} + {t}_{r} ( S [ 0 , 0 ] , S [ 0 , 1 ] , S [ 2 , 0 ] , S [ 3 , 0 ] ) {g}_{1} ) X + ( {t}_{r} ( S [ 0 , 2 ] , S [ 1 , 2 ] , S [ 2 , 2 ] , S [ 3 , 2 ] ) {g}_{0} + {t}_{r} ( S [ 0 , 1 ] , S [ 1 , 1 ] , S [ 2 , 1 ] , S [ 3 , 1 ] ) {g}_{1} + {t}_{r} ( S [ 0 , 0 ] , S [ 1 , 0 ] , S [ 2 , 0 ] , S [ 3 , 0 ] ) ) {X}^{2} + ( {t}_{r} ( S [ 0 , 3 ] , S [ 1 , 3 ] , S [ 2 , 3 ] , S [ 3 , 3 ] ) {g}_{0} + {t}_{r} ( S [ 0 , 2 ] , S [ 1 , 2 ] , S [ 2 , 2 ] , S [ 3 , 2 ] ) {g}_{1} + {t}_{r} ( S [ 0 , 1 ] , S [ 1 , 1 ] , S [ 2 , 1 ] , S [ 3 , 1 ] ) {g}_{0} ) {X}^{3} + ( {t}_{r} ( S [ 0 , 3 ] , S [ 1 , 3 ] , S [ 2 , 3 ] , S [ 3 , 3 ] ) {g}_{1} + {t}_{r} ( S [ 0 , 2 ] , S [ 1 , 2 ] , S [ 2 , 2 ] , S [ 3 , 2 ] ) ) {X}^{4} + {t}_{r} ( S [ 0 , 3 ] , S [ 1 , 3 ] , S [ 2 , 3 ] , S [ 3 , 3 ] ) {X}^{5} \qquad ( Equation J )$$

If a transformed state matrix S* has codewords cᵣ(X) (0≦r<4) as its rows, where

$${c}_{r} ( X ) = {\sum }_{j = 0}^{5} c [ r , j ] {X}^{j} ,$$

then, using Equations H above, for the corresponding state matrix, S:

S[r,0]=c[r,0]g₀⁻¹

S[r,1]=(c[r,1]+c[r,0]g₀⁻¹g₁)g₀⁻¹

S[r,2]=c[r,4]+g₁c[r,5]

S[r,3]=c[r,5] (Equations K)

Thus, given the polynomial cᵣ(X) (0≦r<4) and the generator polynomial g(X), the polynomial c′ᵣ(X) can be determined by using Equations K in Equation J.

Thus, if the input to the MixColumns* function 550 is a transformed state matrix S* having codewords cᵣ(X) (0≦r<4) as its rows, then the output of the MixColumns* function 550 is defined as a transformed state matrix S* having codewords c′ᵣ(X) (0≦r<4) as its rows, where c′ᵣ(X) can be calculated using Equations K in Equation J based on the codewords cᵣ(X).

Thus, if the MixColumns* function 550 is represented as a function F*, and the MixColumns function 150 is represented as a corresponding function F, then F and F* are related in that φ(F(D))=F*(φ(D)) for all blocks of data D. Thus, the MixColumns* function 550 is a transformed function corresponding to the MixColumns function 150.

As discussed earlier, there are other equations, other than Equations H, for expressing the coefficients a₀, a₁, a₂ and a₃ in terms of the coefficients c₀, . . . , c₅. Such other equations could be used in place of Equations H, with this having analogous impact on Equations K.

### (2.2.4) SubBytes*

In some embodiments, the SubBytes* function 530 is implemented using a lookup table. For example, for each possible codeword c(X) of the ECC, the lookup table may contain a corresponding codeword c′(X) of the ECC. The codeword c′(X) corresponding to the initial codeword c(X) is the codeword that results from (a) performing ECC decoding on the initial codeword c(X) to generate a message m(X), (b) using the SubBytes function 130 on each of the coefficients of the message m(X) to generate a new message m′(X), (c) ECC encoding the new message m′(X) to generate c′(X). Then, if the input to the SubBytes* function 530 is a transformed state matrix S* having codewords cᵣ(X) (0≦r<4) as its rows, then the output of the SubBytes* function 530 is defined as a transformed state matrix S* having codewords c′ᵣ(X) (0≦r<4) as its rows, where c′ᵣ(X) is the value in the lookup table corresponding to codeword cᵣ(X). Each codeword is represented by 6 bytes (in embodiments in which the generator polynomial is of degree 2). Hence, the lookup table would be of the order of about 256⁶×6 bytes in size.

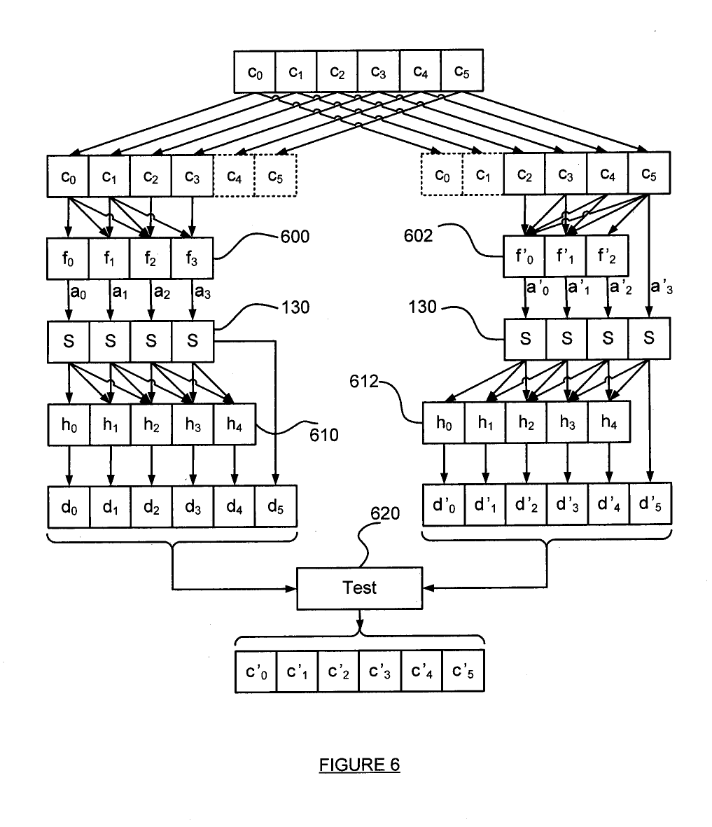

FIG. 6 schematically illustrates an alternative approach for implementing the SubBytes* function 530. As discussed in section 2.1.1 above, Equations B, C, and D can be used to provide two different ways of obtaining the coefficients a₀, a₁, a₂ and a₃ from the coefficients c₀, . . . , c₅ of an input codeword polynomial c(X)=c₀+c₁X+c₂X²+c₃X³+c₄X⁴+c₅X⁵. Thus, as shown in FIG. 6, a codeword polynomial c(X) can be decoded to the original message m(X) in two ways, namely by: (a) at a step 600, using the functions f₀(c₀), f₁(c₀,c₁), f₂(c₀,c₁,c₂) and f₃(c₁,c₂,c₃) as shown in Equations C to derive the coefficients a₀, a₁, a₂ and a₃ of the message m(X) respectively; and (b) at a step 602, using the functions f′₀(c₂c₃,c₄,c₅), f′₁(c₃,c₄,c₅), and f′₂(c₄,c₅) as shown in Equations D and the value c₅ to derive the coefficients a₀, a₁, a₂ and a₃ of the message m(X) respectively—this second set of derived coefficients shall be referred to as a′₀, a′₁, a′₂ and a′₃ (purely to distinguish them in the following from the coefficients a₀, a₁, a₂ and a₃ derived using the functions f₀(c₀), f₁(c₀,c₁), f₂(c₀,c₁,c₂) and f₃(c₁,c₂,c₃)).

Each of the coefficients in the two sets of coefficients {a₀, a₁, a₂ and a₃} and {a′₀, a′₁, a′₂ and a′₃} that are produced by the two decoding operations may then be processed using the original SubBytes function 130 (e.g. using the lookup table Table 1 above). Let the outputs of the SubBytes function 130 that correspond to input values of a₀, a₁, a₂ and a₃ be s₀, s₁, s₂ and s₃ and let the outputs of the SubBytes function 130 that correspond to input values of a′₀, a′₁, a′₂ and a′₃ be s′₀, s′₁, s′₂ and s′₃.

Define

h₀(s₀)=s₀g₀

h₁(s₀,s₁)=s₀g₁+s₁g₀

h₂(s₀,s₁,s₂)=s₀+s₁g₁+s₂g₀

h₃(s₁,s₂,s₃)=s₁+s₂g₁+s₃g₀

h₄(s₂,s₃,s₄)=s₂+s₃g₁+s₄g₀

Then the result of ECC encoding a message s₀+s₁X+s₂X²+s₃X³ is d₀+d₁X+d₂X²+d₃X³+d₄X⁴+d₅X⁵ where d₀=h₀(s₀), d₁=h₁(s₀,s₁), d₂=h₂(s₀,s₁,s₂), d₃=h₃(s₁,s₂,s₃), d₄=h₃(s₂,s₃,s₄) and d₅=s₃. Similarly, the result of ECC encoding a message s′₀+s′₁X+s′₂X²+s′₃X³ is d′₀+d′₁X+d′₂X²+d′₃X³+d′₄X⁴+d′₅X⁵ where d′₀=h₀(s′₀), d′₁=h₁(s′₀,s′₁), d′₂=h₂(s′₀,s′₁,s′₂), d′₃=h₃(s′₁,s′₂,s′₃), d′₄=h₃(s′₂,s′₃,s′₄) and d′₅=s′₃. Therefore, at a step 610, the message s₀+s₁X+s₂X²+s₃X³ is ECC encoded to generate the codeword d₀+d₁X+d₂X²+d₃X³+d₄X⁴+d₅X⁵, and at a step 610, the message s′₀+s′₁X+s′₂X²+s′₃X³ is ECC encoded to generate the codeword d′₀+d′₁X+d′₂X²+d′₃X³+d′₄X⁴+d′₅X⁵.

At a step 620, the two codewords d₀+d₁X+d₂X²+d₃X³+d₄X⁴+d₅X⁵ and d′₀+d′₁X+d′₂X²+d′₃X³+d′₄X⁴+d′₅X⁵ are compared. If no modification of the values cᵢ, aᵢ, a′ᵢ, sᵢ, s′ᵢ, dᵢ and d′ᵢ has occurred, then the two codewords d₀+d₁X+d₂X²+d₃X³+d₄X⁴+d₅X⁵ and d′₀+d′₁X+d′₂X²+d′₃X³+d′₄X⁴+d′₅X⁵ should match and the output of the SubBytes* function 530 is then the codeword d₀+d₁X+d₂X²+d₃X³+d₄X⁴+d₅X⁵. However, if the two codewords d₀+d₁X+d₂X²+d₃X³+d₄X⁴+d₅X⁵ and d′₀+d′₁X+d′₂X²+d′₃X³+d′₄X⁴+d′₅X⁵ do not match, then this indicates that there might have been a modification of one or more of cᵢ, aᵢ, a′ᵢ, sᵢ, s′ᵢ, dᵢ, d′ᵢ or of the process flow through the SubBytes* function 530. Therefore, if the two codewords d₀+d₁X+d₂X²+d₃X³+d₄X⁴+d₅X⁵ and d′₀+d′₁X+d′₂X²+d′₃X³+d′₄X⁴+d′₅X⁵ do not match, then an appropriate action may be taken—this action may be for the function e* or d* to cease operation, or for the SubBytes* function 530 to output a value unrelated to its input, such as a random value, or for the SubBytes* function 530 to attempt to correct the error(s) in the codewords using error correcting capabilities of the ECC and then output the corrected codeword.

The above-described method of implementing the SubBytes* function 530 effectively works as follows. If the input to the SubBytes* function 530 is a transformed state matrix S* having codewords cᵣ(X) (0≦r<4) as its rows, then for each codeword cᵣ(X) (0≦r<4): (a) two separate, different ECC decoding operations on the codeword cᵣ(X) are performed to generate respective messages; (b) the SubBytes function 130 is applied to the coefficients of those messages to generate respective modified messages; (c) respective ECC encoding operations are performed on the modified messages to generate respective new codewords; (d) a comparison operation on the new codewords is performed; and (e) if the new codewords match each other, then the r^{th} row of the transformed state matrix output from the SubBytes* function 530 is set to be that new codeword.

It will be appreciated that other embodiments of the SubBytes* function 530, based on the structure/format shown in FIG. 6, may be used, which may involve performing (in different ways) two or more ECC decoding operations on an input codeword (i.e. a row of the input transformed state matrix S*) to generate respective message, where these two or more ECC decoding operations may be conducted in the same or in different ways from that described above, following which the SubBytes function 130 may be applied to the coefficients of those messages to generate respective modified messages, following which respective ECC encoding operations are performed on the modified messages to generate respective new codewords, and then a comparison of the new codewords may be performed—if the new codewords are the same as each other, then the corresponding row of the output transformed state matrix S* is set to be this new codeword, otherwise an appropriate action may be taken, as discussed above.

### (2.3) Function d*

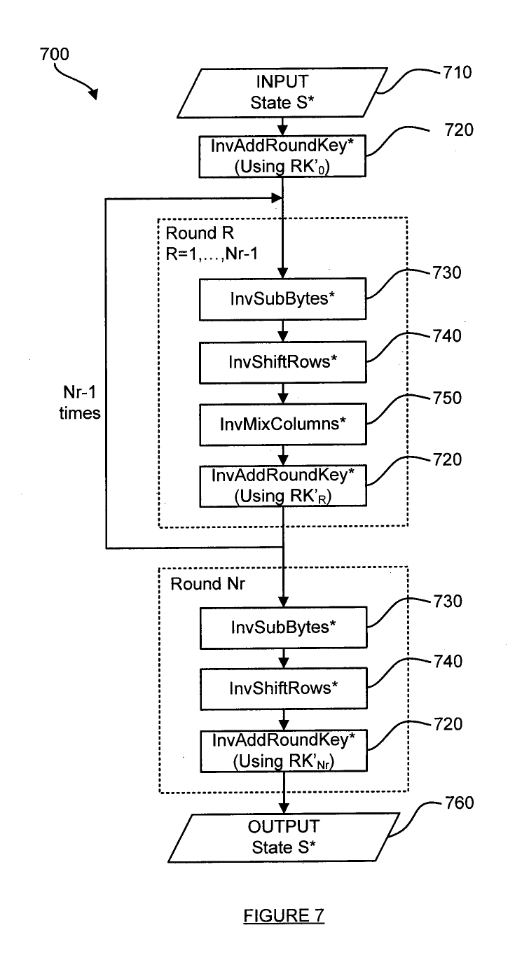

The function d* operates in exactly the same way as the AES decryption described above, except that the input to the function d*, the output of the function d* and the intermediate results of the function d* are transformed state matrices (of size 4x(w+4)), and the functions InvAddRoundKey 220, InvSubBytes 230, InvShiftRows 240, and InvMixColumns 250 are replaced by corresponding transformed versions of those functions, namely an InvAddRoundKey* function 720, an InvSubBytes* function 730, an InvShiftRows* function 740, and an InvMixColumns* function 750 respectively. Each of the InvAddRoundKey* function 720, InvSubBytes* function 730, InvShiftRows* function 740 and InvMixColumns* function 750 operates on a transformed state matrix S* and outputs a transformed state matrix S*. These functions are described in more detail shortly. FIG. 7 schematically illustrates an overview of the function d* when based on the process flow of the decryption 200 of FIG. 2.

If the InvAddRoundKey* function 720 is represented as a function F*, and the InvAddRoundKey function 220 is represented as a corresponding function F, then F and F* are related in that φ(F(D))=F*φ(D)) for all blocks of data D. (Note here that the round key RK is not represented in the above equation—if this were to be included, then we would have φ(F_{RK}(D))=F_{RK}*(φ(D)) for all blocks of data D and all round keys RK). Thus, the InvAddRoundKey* function 720 is a transformed function corresponding to the InvAddRoundKey function 220. Similarly, if the InvSubBytes* function 730 (or the InvShiftRows* function 740 or the InvMixColumns* function 750) is represented as a function F*, and the InvSubBytes function 230 (or the InvShiftRows function 240 or the InvMixColumns function 250) is represented as a corresponding function F, then F and F* are related in that φ(F(D))=F*(φ(D)) for all blocks of data D. Thus, the InvSubBytes* function 730 is a transformed function corresponding to the InvSubBytes function 230; the InvShiftRows* function 740 is a transformed function corresponding to the InvShiftRows function 240; and the InvMixColumns* function 750 is a transformed function corresponding to the MixColumns function 250.

Thus, as the function d* is a concatenation of InvAddRoundKey* functions 720, InvSubBytes* functions 730, InvShiftRows* functions 740, and InvMixColumns* functions 750, for example in the order shown in FIG. 7 (which corresponds to the order shown in FIG. 2), it follows from the above that the function d* is the transformed function corresponding to the function d, i.e. the function d* has the property that φ(d(D))=d*(φ(D)) for all blocks of data D.

### (2.3.1) InvAddRoundKey*

The InvAddRoundKey* function 720 is the same as the AddRoundKey* function 520 (as the InvAddRoundKey function 220 is the same as the AddRoundKey function 120).

### (2.3.2) InvShiftRows*

The InvShiftRows* function 740 will involve left shifts in a similar manner to the ShiftRows* function 540, albeit with different numbers of left shifts (as a right shift of n positions of a row of a state S is equal to a left shift of 4-n positions of that row of the state S, for 0≦n≦3). Thus, the same equations as for the ShiftRows* function 540 (but with corresponding different number of iterations depending on how many left shifts a row of the state S undergoes for the InvShiftRows function 240) are used for the InvShiftRows* function 740. In particular, if the input to the InvShiftRows* function 740 is a transformed state matrix S* having codewords cᵣ(X) (0≦r<4) as its rows, then the output of the InvShiftRows* function 740 is defined as a transformed state matrix S* having codewords c′ᵣ(X) (0≦r<4) as its rows, where c′ᵣ(X) can be calculated using by applying the Equation F iteratively to the codeword cᵣ(X) (4-r)mod 4 times.

### (2.3.4) InvMixColumns*

The InvMixColumns* function 750 is performed in exactly the same way as for the MixColumns* function 550, except that the function t₀, t₁, t₂ and t₃ in Equations I are replace with the functions

t₀(α,β,γ,δ)=eα+bβ+dγ+9δ

t₁(α,β,γ,δ)=9α+eβ+bγ+dδ

t₂(α,β,γ,δ)=dα+9β+eγ+bδ

t₃(α,β,γ,δ)=bα+dβ+9γ+eδ

(where the coefficients are in hexadecimal).

### (2.3.5) InvSubBytes*

The InvSubBytes* function 730 is performed in exactly the same way as for the SubBytes* function 530, except that the InvSubBytes function 230 is used in place of the SubBytes function 130.

### (2.4) Provision of e* and d*

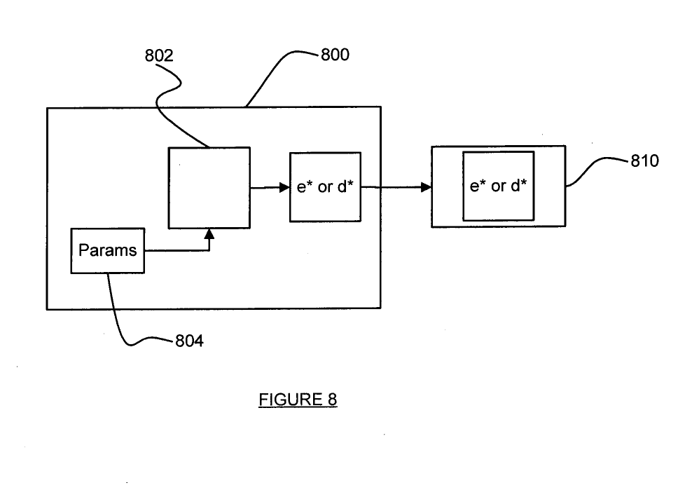

FIG. 8 schematically illustrates a system according to an embodiment of the invention.

A provider 800 is arranged to using a generation program 802 to generate a corresponding implementation e* or d* of the initial algorithm e or d. The generation program 802 may make use of one or more parameters 804 to form e* or d*. These parameters 804 may, for example, be parameters that define the ECC that is to be used in e* or d*. The provider 800 provides the implementation e* or d* to a client 810, so that the client 810 can execute, use or implement e* or d*. The implementation of e* or d* may be provided to the client 810 as software and/or hardware.

### (2.5) Modifications

In section 2.1 above, the ECC encoding was described. In particular, the ECC encoding at the step 400 was described as treating the four rows of the state S as four messages to which ECC encoding is applied, with the resulting four codewords forming, or being represented by, the corresponding rows of the transformed state matrix S*. However, it will be appreciated that the four messages could be formed from the four columns of S instead. Indeed, the four messages could be formed from any four sets of coefficients of the state S—preferably the union of these sets of coefficients is the full set of 16 available coefficients. Moreover, it will be appreciated that the messages to which the ECC encoding is applied need not be of length four but could, instead, be of a different length. Consequently, there need not be four messages to which the ECC encoding is applied—a different number of messages could be used. For example, two messages of length eight bytes could be formed (e.g. the first two rows of the state S could form a first message and the last two rows of the state S could form a second message), with ECC encoding being applied to these two messages. Additionally, whilst the transformed state matrix S* has been described as being formed using the codewords as its rows, it will be appreciated that this is not essential—for example, the transformed state matrix S* could be formed by setting its columns to be the coefficients of the codewords (so that the transformed state matrix is then a (4+w)x4 matrix); other ways of representing the codewords with a transformed state matrix could be used. It will also be appreciated that not all of the elements of the state S need to be ECC encoded to form the transformed state matrix S*. Other variants for applying ECC encoding to the elements of the state matrix S to form a corresponding transformed state matrix S* are possible, as would be appreciated by the skilled person. The equations set out above would then be modified accordingly.

The alphabet used for the ECC processing need not comprise bytes—instead, ECC processing could be used that involves a different alphabet, such as an alphabet whose elements are g-bit words, where g>0. It will be appreciated that the above-described systems of equations would be modified accordingly.

The functions set out above have been described with respect to particular sets of equations. However, as mentioned above, other formulations of these equations can be used instead to generate the same result. The equations, or their implementations, could be optimized—for example, when implementing an embodiment of the invention using a target device with a particular architecture, the equations used could be optimized for that device or architecture. It will, therefore, be appreciated that embodiments of the invention are not limited to the equations set out above, but may be based on other equivalent sets of equations.

In some embodiments of the invention, the functions set out above may be implemented as obfuscated functions. In particular, for software implementations of the functions e* and d*, software obfuscation techniques may be applied to generated an obfuscated implementation of the functions e* and d*—such obfuscation techniques are well-known and shall not, therefore, be discussed in more detail herein.

The AES algorithm has been described above with reference to its current parameter set—in particular, the size of the block of data, the sizes of the keys, the number of rounds, the irreducible polynomials used, the particular operation of the functions involved, etc. are based on the current specification of the AES algorithm. It will be appreciated that the above-described techniques may be applied analogously to an updated form of the AES algorithm should the configuration of the AES algorithm be updated at some point in the future.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may together be implemented by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1-12. (canceled)

13. A method of cryptographically processing a block of data, the method comprising:
receiving an encoded version of the block of data, wherein the encoded version of the block of data comprises the block of data encoded, at least in part, using an error control code; and
processing the encoded version of the block of data using a predetermined function to generate an output, wherein the predetermined function is arranged so that the result of processing, with the predetermined function, a quantity of data encoded, at least in part, using the error control code equals the result of encoding, at least in part, with the error control code the result of performing encryption or decryption of the quantity of data according to the Advanced Encryption Standard, AES.

14. The method of claim 13, wherein the predetermined function comprises one or more sub-functions, wherein each of the sub-functions is arranged so that the result of processing, with that sub-function, a quantity of data encoded, at least in part, using the error control code equals the result of encoding, at least in part, with the error control code the result of processing the quantity of data according to a corresponding processing step of the AES, wherein the corresponding processing step is one of:
the AddRoundKey function;
the MixColumns function;
the ShiftRows function;
the SubBytes function;
the InvMixColumns function;
the InvShiftRows function;
the InvSubBytes function.

15. The method of claim 13, comprising:
using the error control code to detect whether there is an error in one or more of: the received encoded version of the block of data, the output, or an intermediate result of the predetermined function; and
if an error is detected, performing a corresponding action.

16. The method of claim 15, wherein the corresponding action comprises one of: (a) setting the output to be substantially unrelated to the received encoded version of the block of data; (b) setting the output to be a random value; (c) ceasing performing the predetermined function; and (d) performing an error correction operation of the error control code to correct the error.

17. The method of claim 13, comprising:
performing a decoding operation of the error control code on the output.

18. The method of claim 13, wherein the encoded version of the block of data and intermediate results of the predetermined function are each represented by corresponding first matrices, wherein each first matrix corresponds to a state matrix that would occur if the encryption or decryption according to the AES were performed on the block of data, wherein each first matrix corresponds to a state matrix in that elements of that first matrix are coefficients of codewords that would result from encoding, with the error control code, messages formed from corresponding elements of the corresponding state matrix.

19. The method of claim 18, wherein for each row or column of each first matrix, the elements of that row or column are coefficients of a codeword that would result from encoding, with the error control code, a message formed from the elements of a corresponding row or column of the corresponding state matrix.

20. A method of providing a block of data to an entity arranged to carry out a method according to claim 13, comprising:
generating an encoded version of the block of data, wherein the encoded version of the block of data comprises the block of data encoded, at least in part, using an error control code;
applying a modification to the encoded version of the block of data to form a modified encoded version of the block of data, wherein the modification is such that the error control code can correct the modification to produce the encoded version of the block of data from the modified encoded version of the block of data; and
providing the modified encoded version of the block of data to the entity.

21. A method of enabling a data processor to cryptographically process a block of data, the method comprising:
generating one or more modules which, when executed, carry out a method according to any one of claim 13; and
configuring the data processor to execute the one or more modules.

22. An apparatus comprising a processor, wherein the processor is arranged to
cryptographically process a block of data by:
receiving an encoded version of the block of data, wherein the encoded version of the block of data comprises the block of data encoded, at least in part, using an error control code; and
processing the encoded version of the block of data using a predetermined function to generate an output, wherein the predetermined function is arranged so that the result of processing, with the predetermined function, a quantity of data encoded, at least in part, using the error control code equals the result of encoding, at least in part, with the error control code the result of performing encryption or decryption of the quantity of data according to the Advanced Encryption Standard, AES.

23. A computer readable medium storing a computer program which, when executed by one or more processors, causes the one or more processors to cryptographically process a block of data by:
receiving an encoded version of the block of data, wherein the encoded version of the block of data comprises the block of data encoded, at least in part, using an error control code; and
processing the encoded version of the block of data using a predetermined function to generate an output, wherein the predetermined function is arranged so that the result of processing, with the predetermined function, a quantity of data encoded, at least in part, using the error control code equals the result of encoding, at least in part, with the error control code the result of performing encryption or decryption of the quantity of data according to the Advanced Encryption Standard, AES.

24. A first apparatus arranged to provide a block of data to a second apparatus according to claim 22, the first apparatus comprising one or more processors arranged to:
generate an encoded version of the block of data, wherein the encoded version of the block of data comprises the block of data encoded, at least in part, using an error control code;
apply a modification to the encoded version of the block of data to form a modified encoded version of the block of data, wherein the modification is such that the error control code can correct the modification to produce the encoded version of the block of data from the modified encoded version of the block of data; and
provide the modified encoded version of the block of data to the second apparatus.

25. A computer readable medium storing a computer program which, when executed by one or more processors, causes the one or more processors to provide a block of data to an apparatus according to claim 22 by:
generating an encoded version of the block of data, wherein the encoded version of the block of data comprises the block of data encoded, at least in part, using an error control code;
applying a modification to the encoded version of the block of data to form a modified encoded version of the block of data, wherein the modification is such that the error control code can correct the modification to produce the encoded version of the block of data from the modified encoded version of the block of data; and
providing the modified encoded version of the block of data to the apparatus.
